(19) United States
(12) Patent Application Publication
(10) Pub. No.: US 2019/0233778 A1
(43) Pub. Date: Aug. 1, 2019

(54) DETERGENT COMPOSITION HAVING A FLOW LIMIT

(71) Applicant: Henkel AG & Co. KGaA, Duesseldorf (DE)

(72) Inventors: Anna Klemmer, Duesseldorf (DE); Peter Schmiedel, Duesseldorf (DE); Filiz Yapici, Duesseldorf (DE); Olga Morozova, Duesseldorf (DE)

(73) Assignee: Henkel AG & Co. KGaA, Duesseldorf (DE)

(21) Appl. No.: 16/381,875

(22) Filed: Apr. 11, 2019

Related U.S. Application Data
(63) Continuation of application No. PCT/EP2017/075815, filed on Oct. 10, 2017.

(30) Foreign Application Priority Data
Oct. 12, 2016 (DE) 10 2016 219 862.9

(51) Int. Cl. C11D 17/00; C11D 1/83; C11D 3/382

(52) U.S. Cl. CPC C11D 17/0021; C11D 17/0026; C11D 1/22; C11D 3/382; C11D 1/83

(57) ABSTRACT

The production of a flow limit in liquid surfactant compositions by way of the use of a micro emulsion containing, in each case based on the total weight of the emulsion, a) a liquid phase, b) a total quantity of 10 wt % to 99.0 wt % of at least one non-polymer organic thickening agent having a molecular weight in the range from 100 g/mol to 500 g/mol as an emulsified phase, c) a total quantity of 0.001 wt % to 89.0 wt % of a surfactant system containing at least one non-ionic surfactant.

### FIELD OF THE INVENTION

The present invention is in the technical field of liquid surfactant compositions and relates to producing a yield point in said liquid surfactant compositions.

The present invention further relates to a method for producing a microemulsion of a non-polymeric, organic thickening agent and to producing said liquid surfactant compositions having a yield point by using said microemulsion.

### BACKGROUND OF THE INVENTION

Either those ingredients that dissolve in the liquid phase of the agent or those that can be accordingly homogeneously suspended in an undissolved manner are available for incorporation into liquid surfactant compositions, in particular washing or cleaning agents. For insoluble ingredients, a stable, homogeneous suspension is required for the function and aesthetics of the washing or cleaning agent. Sedimented solid particles may clump together and, when used, may lead to local excess concentrations of the ingredient and thus to uneven dosing per wash load. In addition, visible clumps, greasy deposits or residues of the solid ingredient on an e.g. transparent wall of the storage container are not aesthetically pleasing.

The incorporation of certain, optionally colored, solid particles, which are visible to the naked human eye in suspension in a transparent or translucent, liquid phase as individual particles, is often referred to as speckles. For this purpose, corresponding particles have an appropriate particle size and are aesthetically attractive to the consumer. Microcapsules are also solid ingredients and include any type of capsule known to a person skilled in the art, but in particular core-shell capsules and matrix capsules. Matrix capsules are porous shaped bodies that have a structure similar to a sponge. Core-shell capsules are shaped bodies that have a core and a shell. However, all of these solid particles, in particular the speckles, tend towards sedimentation in liquid surfactant compositions.

The sedimentation of particles out of the suspension is usually prevented by the use of surfactant compositions having a yield point. A yield point can be produced by selecting specific surfactant combinations, usually in the presence of an electrolyte salt, by establishing a lamellar phase. It is also conceivable to use selected polymeric thickeners for producing a yield point.

In particular, it is difficult to provide surfactant compositions having a high surfactant concentration with a yield point in the range from 0.01 to 5 Pa. By using lyotropic liquid-crystalline mesophases, an excessively high yield point is usually achieved at a high surfactant concentration. In such a case, the flow behavior is inhomogeneous (what is known as “clumpy” flow).

Furthermore, an excessively high yield point results in the suspended particles adhering to the wall of the storage container for the surfactant composition. If polymer thickeners are used to form the yield point, at a high surfactant concentration this is sometimes achieved by using a very high quantity of the polymeric thickener, and often is not achieved at all. Large quantities of thickener impair the cleaning performance of surfactant compositions, and in textile treatment this can in particular additionally result in graying of the textile.

WO 2011/120772 and WO 2011/120799 relate to the preparation of liquid washing agents having a yield point, where an already structured premix having a yield point is first produced and said premix is mixed with an aqueous surfactant composition.

WO 2011/031940 relates to a structuring agent for liquid and gel washing agents that contains 2 to 10 wt. % crystals of a glyceride, preferably hydrogenated castor oil, and 2 to 10 wt. % alkanol amine and 5 to 60 wt. % of the anion of an anionic surfactant, but contains no inorganic cations.

WO 2002/40627 relates to aqueous liquid washing agents which contain a substantive agent for textiles and have low solubility, a crystalline hydroxyl group-containing stabilizer, and a non-surfactant, dissolved ingredient. The premix used to prepare the liquid washing agent contains water, surfactant and 0.1 to 5 wt. % of the above-mentioned thickening agent in crystalline form as the solid.

WO 2005/012475 likewise relates to liquid washing agents having a yield point, which agents are prepared by the use of an already structured premix, containing a hydroxyl group-containing thickening agent in crystalline form.

WO 2015/200062 relates to a premix for preparing liquid washing agents having a yield point, which premix is already structured by a crystalline, hydroxyl group-containing thickening agent and also contains an alkyl sulfate surfactant.

According to the disclosure of the cited documents, the above-described premixes of the prior art are liquid, viscous and already structured. However, they contain thickening agent which has a minimal structuring effect, as a result of which either a lot of water or a lot of foreign surfactant is introduced into the final liquid washing agent by the premix during preparation of the liquid washing agent. A person skilled in the art reproducing the disclosure of these documents determines that the premixes provided according to the preparation instructions in the prior art include inhomogeneous incorporation of the thickening agent and are therefore difficult to dose. Liquid washing agents which are produced using the premixes of the prior art have a precipitate and do not have a yield point.

### BRIEF SUMMARY OF THE INVENTION

The problem addressed by the present invention is that of providing liquid surfactant compositions, in particular washing or cleaning agents having excellent washing or cleaning performance, which have a yield point and in which solid particles (in particular speckles) can be homogeneously suspended, such that said particles remain stable in suspension under storage conditions.

For this purpose, any liquid surfactant compositions without a yield point are to be structured by adding a thickening agent, without the surfactant system of the resulting liquid surfactant composition with a yield point undergoing a significant change by the addition of a liquid premix containing the structuring thickening agent in comparison with the unstructured surfactant composition. The premix used should ensure that as few additional foreign surfactants as possible are introduced into the liquid surfactant composition. The premix used for structuring should also be used in small amounts.

In addition, the problem was that of providing a preparation method for above-mentioned liquid surfactant compositions in which (in particular in a continuous preparation process) a thickening agent can be easily dosed and forms as few depositions as possible in the production facility.

Surprisingly, it has been found that by using a microemulsion of a non-polymeric thickening agent, liquid surfactant compositions having a yield point can be prepared. If these surfactant compositions are used as a continuous phase of a suspension, the solid phase is suspended homogeneously and stably therein. In addition, a thermodynamically multiphase surfactant formulation can prevent macroscopic separation. By adding the above-mentioned microemulsion, a formulation that, similarly to an emulsion, consists of a plurality of immiscible liquid phases can be converted into a storage-stable, macroscopically single-phase and homogeneous product.

The microemulsion used in order to achieve the yield point can be easily processed and dosed due to its flowability.

A first subject matter of the invention is therefore a microemulsion containing, in each case based on the total weight of the emulsion,

a) a liquid phase,
b) a total amount from 2.0 wt. % to 90.0 wt. % of at least one non-polymeric, organic thickening agent having a molecular weight in the range from 100 g/mol to 1500 g/mol as the emulsified phase,
c) a total amount from 2.0 wt. % to 89.0 wt. % of a surfactant system, containing at least one non-ionic surfactant.

Within the meaning of the invention, the definition of a number range which is intended to be “between” two range boundaries does not include the range boundaries, according to general linguistic usage. Number ranges which are defined from one range boundary to another range boundary include the range boundaries.

In general, “at least one,” as used herein, means 1, 2, 3, 4, 5, 6, 7, 8, 9 or more, where the term refers to the type of substance mentioned and not the absolute number of molecules.

The surfactant compositions according to the invention obtain their yield point according to the invention by the use of the above-mentioned microemulsions having a polymeric, organic thickening agent.

The yield point refers to the lowest stress (force per surface area) above which a plastic substance behaves rheologically, like a liquid. It is therefore given in pascals (Pa).

The yield points of the washing or cleaning agents were measured using an AR G2-type rotational rheometer from TA-Instruments. This is what is known as a controlled shear stress rheometer.

In order to measure a yield point using a controlled shear stress rheometer, various methods are described in the literature that are known to a person skilled in the art.

In order to determine the yield points within the context of the present invention, the following was carried out at 20 ° C.:

Shear stress σ increasing at intervals over time was applied to the samples in the rheometer in a stepped-flow procedure. For example, the shear stress can be increased from the smallest possible value (e.g. 2 mPa) to e.g. 10 Pa over the course of 10 minutes with 10 points per shear stress decade. In the process, the time interval is selected such that the measurement is carried out “quasistatically,” i.e. such that the deformation of the sample for each specified shear stress value can come into equilibrium. The equilibrium deformation y of the sample is measured as a function of this shear stress. The deformation is plotted against the shear stress in a double-logarithmic plot. Provided that the sample tested has a yield point, a distinction can clearly be made between two regions in this plot. Below a certain shear stress, purely elastic deformation occurs in accordance with Hooke's law. The gradient of the curve γ (σ) (log-log plot) in this region is one. Above this shear stress, the yield region begins and the gradient of the curve rises steeply. The shear stress at which the curve deviates sharply, i.e. the transition from elastic to plastic deformation, marks the yield point. It is possible to easily determine the deviation point by applying tangents to the two parts of the curve. Samples without a yield point do not have a characteristic deviation in the γ (σ) function.

Non-polymeric thickening agent” is understood according to the invention to mean a compound which has a thickening effect and is not obtained by the polyreaction of monomers.

Monomers are molecules which form a polymer by means of polyreaction, said polymer having repeating units in its molecular structure which result from the monomer. The molecular structure of a polymer contains at least 10 repeating units resulting from the same monomer.

A thickening agent has a thickening effect, whereby it increases the viscosity of the surfactant composition according to the invention by at least 500 mPas in a use amount of 0.1 wt. %.

Within the context of this invention, unless described otherwise, viscosity is determined using a rotational rheometer (cone-plate (40 mm diameter, 2° conical angle)) at 0.5 rpm and 20° C.

A substance (e.g. thickening agent) is organic if it contains carbon atoms and hydrogen atoms bonded thereto.

Unless defined otherwise, a substance (e.g. the surfactant composition according to the invention) is a liquid if it is liquid at 25° C. and 1013 mbar.

Unless defined otherwise, a substance is a solid if it has a melting point of lower than 25° C. at 1013 mbar. Capsules are considered to be solid within the meaning of the invention if they are macroscopically in the form of solid matter at 20° C. despite potentially containing liquid components.

Within the context of the invention, a microemulsion is defined as a dispersion, which is visible to the naked eye as homogeneous and transparent at a defined temperature and at 1013 mbar, of at least two phases which, at this temperature and at 1013 mbar, are each liquid and cannot be mixed together.

Various nanostructures fall within the homogeneous and transparent single-phase region depending on the total surfactant concentration and/or temperature. The structure size decreases as the surfactant concentration increases. In a temperature-dependent analysis of the structure sizes at a constant surfactant concentration, the continuous domains invert from e.g. water-continuous to oil-continuous (or vice versa). In this case, it is also possible to pass through bicontinuous regions or double-layered structures. Moreover, there are bicontinuous structures in microemulsions, too. Typically, microemulsions are clear, as their structure size is in the nm range considerably below the wavelength of visible light. Within the context of the present invention, this clearness is also considered to be an indicator of the presence of a microemulsion. According to Winsor, microemulsion systems consisting of a water component, an oil component and a surfactant (also: Am phi phil) can be divided into 4 types according to their phase equilibria.

In a Winsor Type I microemulsion system, the surfactant is soluble primarily in water and in an oil-in-water (O/W) form of microemulsion. The microemulsion consists of a surfactant-rich aqueous phase (O/W microemulsion) and an excess, but surfactant-poor, oil phase.

In a Winsor Type II microemulsion system, the surfactant is soluble primarily in an oil phase and in a water-in-oil (W/O) form of microemulsion. The microemulsion consists of a surfactant-rich oil phase (W/O microemulsion) and an excess, but surfactant-poor, aqueous phase.

A Winsor Type III microemulsion system is a typically bicontinuous microemulsion, also known as a middle-phase microemulsion, consisting of a surfactant-rich middle phase, which coexists with both a surfactant-poor aqueous phase and a surfactant-poor oil phase.

A Winsor Type IV microemulsion system, however, is a single-phase homogeneous mixture and is in total one microemulsion, in contrast to Winsor Types Ito III, which consist of 2 or 3 phases of which only one phase is a microemulsion.

The microemulsions according to the invention are homogeneous, thermodynamically stable and optically isotropic.

A substance is considered transparent if a letter “A” (Times New Roman, font size 12 pt.) positioned behind the substance can be read through the substance with the naked eye at a distance of 1 cm and a substance thickness of 1 cm.

According to the invention, a surfactant system consists of at least one amphiphilic compound as a constituent of the microemulsion, where the amphiphilic compounds of the surfactant system are different from the above-mentioned thickening agent and the above-mentioned liquid phase. The surfactant system according to the invention necessarily contains, as an amphiphilic compound, at least one non-ionic surfactant, although it may also contain other surfactants.

The surfactant system contained in the microemulsion according to the invention having at least one non-ionic surfactant is characterized preferably by a particularly low interfacial tension in comparison with the above-mentioned thickening agent. Interfacial tensions of <5 mN/m, particularly preferably <0.5 mN/m, and very particularly preferably <0.05 mN/m, are preferred. The surfactant system used according to the invention is generally suitable for forming a microemulsion. Accordingly, “suitable for forming a microemulsion,” as used in the context of the microemulsions described herein, means that these microemulsions comprise a surfactant system having the described properties and, under the test conditions described in the following, i.e. at a temperature in the range from 0 to 100° C., preferably 40 to 98° C., more preferably 75 to 95° C., and a water/oil system having a mass ratio of water:oil from 99:1 to 9:1, the oil being a triacylglyceride for example, such as in particular hydrogenated castor oil, can form a Winsor Type IV microemulsion.

“Fishtail point,” as used herein, is understood to mean the maximum expansion of the single-phase, optically isotropic microemulsion region as far as minimum surfactant concentrations, at which the upper and lower phase boundaries intersect, which delimit the same single-phase region. In this case, “upper phase boundary” and “lower phase boundary” preferably describe the transitions between the microemulsion phase (single-phase Winsor Type IV microemulsions) and released excess phases (double-phase Winsor Type I or II microemulsions) or other structured phases.

Microemulsions that are preferred according to the invention contain a surfactant system that has a fishtail point in the range from 0.01 wt. % to 80 wt. %, preferably 0.1 wt. % to 70 wt. %, particularly preferably 0.2 wt. % to 60 wt. %.

In order to determine the fishtail point and these phase boundaries, a reference system is defined. The method described in the following relates to ternary or higher-grade mixtures consisting of at least one polar component, typically a polar solvent, in this case in particular water, at least one nonpolar component, typically the thickening agent that can be used according to the invention in its liquid form (always referred to as “oil” in the following) and at least one amphiphilic component, i.e. the surfactant or surfactant system in this case. The methods described in the following can be carried out in an automated manner for each thickening agent according to the invention.

### DETAILED DESCRIPTION OF THE INVENTION

In a first embodiment of the method, the fishtail point is determined in a temperature-dependent manner as an intersection of the phase boundaries, the mixture ratios of the surfactant components being kept constant when a surfactant system consisting of a plurality of surfactants is used.

The point of intersection of the two phase boundaries is isoplethal in each case based on a single-phase system and high concentrations of surfactant by varying the temperature and subsequently diluting, in a step-wise manner, at a constant water:oil ratio (i.e. in particular a water:oil mass ratio in the range from 99:1 to 9:1, the oil being the thickener according to the invention, in particular a triglyceride, particularly preferably hydrogenated castor oil) and once more determining the phase boundaries by varying the temperature, in particular in a range from 0 to 100° C., preferably 40 to 98° C., more preferably 60 to 95° C. Here, the equilibrium of the composition to be tested must be set after each temperature adjustment. For reasons of clarity, the respective phase transition points (temperature) are plotted as a function of the total concentration of the surfactants (Y-axis: temperature; X-axis: surfactant concentration; at given water:oil ratio).

“Approximately,” as used herein in relation to numerical values, refers to the numerical value ±10%, preferably ±5%.

The microemulsion according to the invention preferably has a temperature between 0 and 100° C., preferably from 40 to 98° C., more preferably from 60 to 95° C.

Preferred microemulsions are characterized in that the mean curvature of the amphiphilic film in the single-phase region of the microemulsion is 0 in the temperature range 0 to 100° C., preferably 40 to 98° C., more preferably 60 to 95° C. The mean curvature can be reasonably determined by means of conductivity within the given single-phase region, as described, for example, by Strey (R. Strey, Colloid and Polymer Science, vol. 272, pp. 1005-1019 (1994)).

Preferred ranges for the fishtail point are in the range from 0.01 to 80 wt. % total surfactant (X-axis) and 0 to 100° C. (Y-axis), more preferably 0.1 to 70 wt. % total surfactant and 40 to 98° C., most preferably 0.2 to 60 wt. % total surfactant and 60 to 95° C. In this case, the water:oil mass ratio is preferably a constant value in the range from 99:1 to 9:1, the oil preferably being triacylglyceride, in particular hydrogenated castor oil.

For the purposes of determination, a mixture of oil, amphiphile (surfactant(s)) and water is generally weighed-in in a (glass) vessel (including a Teflon-coated magnetic stirring rod) that is to be sealed in a gas-tight manner and is then stirred in a thermostatically controlled water bath until a thermal equilibrium is set. The temperature for the fishtail point is selected so as to be above the melting point of the thickening agent according to the invention, preferably in a range from 0 to 100° C., preferably 40 to 98° C., more preferably 60 to 95° C.

Alternatively or additionally to the above-described temperature-dependent determining process, the fishtail point in a surfactant system consisting of a plurality of amphiphiles (e.g. surfactants) can also be determined depending on the concentration of the surfactants used. For this purpose, at least one first surfactant C1, it also being possible for said at least one first surfactant to be a mixture of a plurality of surfactants, is provided in a concentration that is below the fishtail point and is added to a second amphiphile/surfactant C2 (which is different from the at least one surfactant C1) at a constant temperature and constant water:oil ratio, until the entire phase space is made clear or the maximum concentration detected according to the invention is reached. After small amounts of surfactant C2 have been added gradually, the relevant phase state is documented after the equilibrium has been set, a distinction being made between isotropic single-phase and multi-phase states. On the basis of the added surfactant amount of C2, a transition concentration of the relevant surfactant, the total surfactant concentration and the relative ratio of the surfactants to one another can be determined for any desired surfactant concentration of C1 for each phase transition. For reasons of clarity, the respective phase transition points (temperature) are plotted as a function of the total concentration of the surfactants (Y-axis: concentration C2; X-axis: surfactant concentration C1+C2; at given water:oil ratio and temperature). After all the phase transitions for at least five surfactant concentrations C1 have been determined, the course of the phase boundaries can be described, taking care that the initial surfactant concentrations are selected such that the intersection of the phase boundaries is described as being as narrow as possible. In systems of this kind consisting of a plurality of surfactants, it is preferred that the HLB values of the surfactant(s) C1 and of the amphiphile/surfactant C2 differ by a value of at most 10, preferably no more than 8, more preferably no more than 5, most preferably no more than 3.

Microemulsions that are preferred according to the invention are characterized in that the fishtail point is in the range from 0.01 to 80 wt. % total surfactant (X-axis) and 0 to 50 wt. % surfactant C2 (Y-axis), more preferably 0.1 to 70 wt. % total surfactant and 0.01 to 40 wt. % surfactant C2, most preferably 0.2 to 60 wt. % total surfactant and 1 to 35 wt. % surfactant C2.

In this case, the water:oil mass ratio is preferably a constant value in the range from 99:1 to 9:1, the oil preferably being a triacylglyceride, in particular hydrogenated castor oil.

The microemulsion can contain lipophilic or hydrophilic thickening agents as the continuous medium. In a bicontinuous microemulsion, the respective thickeners are localized either in the oil-rich phase or in the water-rich phase. It is preferred according to the invention if the above-mentioned thickener is in the oil-rich phase of the microemulsion.

The microemulsion according to the invention is preferably characterized in that the liquid phase and the emulsified phase are present as bicontinuous phases or as layers of an L_{α}-phase, in particular as bicontinuous phases.

A necessary component of the microemulsion according to the invention is a non-polymeric, organic thickening agent having a molecular weight in the range from 100 g/mol to 1500 g/mol (in particular from 150 g/mol to 1250 g/mol) as the emulsified phase.

It is preferred according to the invention if the above-mentioned thickening agent has a melting point at 1013 mbar of between 30° C. and 100° C., in particular between 40° C. and 95° C., very particularly preferably from 60° C. to 90° C.

The total amount of said thickening agent is 1 to 99 wt. %, based on the total weight of the above-mentioned microemulsion. In this case, it is in turn preferred if the minimum amount of this thickening agent is a total amount of at least 20 wt. %, in particular 30 wt. %, particularly preferably at least 40 wt. %, very particularly preferably at least 50 wt. %.

Microemulsions that are particularly preferred according to the invention contain, based on the total weight of the microemulsion, a total amount of the above-mentioned thickening agent from 20 wt. % to 95 wt. %. In this case, it is in turn preferred if the minimum amount of this thickening agent is a total amount of at least 30 wt. %, particularly preferably at least 40 wt. %, very particularly preferably at least 50 wt. %.

Microemulsions that are very particularly preferred according to the invention contain, based on the total weight of the microemulsion, a total amount of the above-mentioned thickening agent from 20 wt. % to 90 wt. %. In this case, it is in turn preferred if the minimum amount of this thickening agent is a total amount of at least 30 wt. %, particularly preferably at least 40 wt. %, very particularly preferably at least 50 wt. %.

The at least one low-molecular-weight, organic thickening agent that is preferably suitable for the microemulsion according to the invention is selected from hydrogenated castor oil, 12-hydroxyoctadec-9-anoic acid, 12-hydroxystearic acid, a glyceride having at least two 12-hydroxyoctadec-9-anoic acid functional groups, triricinolein, a glyceride having at least two 12-hydroxystearic acid functional groups, tris-12-hydroxystearic acid, 4,6-O-benzylidene monosaccharide, C₈-C₂₂ alkylamide derivatives of D-glucosamine, urea derivatives, gemini surfactants (in particular N-lauroyl-L-lysine ethyl ester), or mixtures thereof.

All the fatty acids of Gelled Bicontinuous Microemulsions: A New Type of Orthogonal Self-Assembled Systems by Michaela Laupheimer (Dissertation, 2013, Uni Stuttgart) are also suitable as a suitable at least one low-molecular-weight, organic thickening agent.

The microemulsion according to the invention necessarily contains, based on the total weight of the microemulsion, a total amount from 0.001 wt. % to 89.0 wt. % (preferably a total amount from 1 wt. % to 60 wt. %, in particular 2 wt. % to 50 wt. %) of a surfactant system, containing at least one non-ionic surfactant.

Suitable non-ionic surfactants include alkoxylated fatty alcohols, alkoxylated oxo-alcohols, alkoxylated fatty acid alkyl esters, fatty acid amides, fatty acid alkanolamides, alkoxylated fatty acid amides, hydroxy mixed ethers, sorbitan fatty acid esters, polyhydroxy fatty acid amides, alkylphenol polyglycol ethers, amine oxides, alkyl(poly)glycosides, and mixtures thereof.

Fatty alcohol alkoxylates in particular are suitable as non-ionic surfactants. In different embodiments, the agents therefore contain at least one non-ionic surfactant of the formula

R¹—O—(AO)ₘ—H,

in which
R¹ represents a linear or branched, substituted or unsubstituted alkyl functional group,
AO represents an ethylene oxide (EO) or propylene oxide (PO) group,
m represents an integer from 1 to 50.

In the above-mentioned formula, R¹ represents a linear or branched, substituted or unsubstituted alkyl functional group, preferably a linear, unsubstituted alkyl functional group, particularly preferably a fatty alcohol functional group having 8 to 20 carbon atoms. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

AO represents an ethylene oxide (EO) or propylene oxide (PO) group, preferably an ethylene oxide group or mixtures of ethylene oxide units and propylene oxide units. The index m represents an integer from 1 to 50, preferably from 1 to 20, and in particular from 2 to 10. Very particularly preferably, m represents the numbers 2, 3, 4, 5, 6, 7 or 8.

At least one C₈₋₂₀ alkyl ether, preferably at least one C₈₋₂₀ fatty alcohol alkoxylate having 1 to 10 EO and 0 to 10 PO, is particularly preferably suitable as the non-ionic surfactant. Moreover, fatty alcohol alkoxylates that are very particularly preferably to be used are compounds of the formula

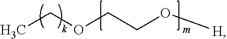

where k=7 to 19, and m=2, 3, 4, 5, 6, 7, 8, 9 or 10. Very particularly preferred representatives are C₁₂₋₁₈ fatty alcohols with 7 EO (k=11-17, m=7).

Preferred additional non-ionic surfactants are, for example, those which have alternating ethylene oxide (EO) and propylene oxide (PO) units. Among these, in turn, surfactants with EO-PO-EO-PO blocks are preferred, one to ten EO and PO groups being respectively bonded to each other before a block follows from the respective other groups. Here, non-ionic surfactants of the general formula

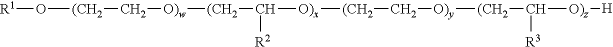

are preferred, in which R¹ represents a straight-chain or branched C₆₋₂₄ alkyl functional group; R² and R³ represent —CH₃, and the indices w, x, y and z, independently of one another, represent O or integers of 1 to 10, at least one of w and y and at least one of x and z not being 0.

In particular, non-ionic surfactants are also preferred which have a C₈₋₂₀ alkyl functional group having 1 to 10 ethylene oxide units and 1 to 10 propylene oxide units.

Amine oxides, for example, are also suitable as non-ionic surfactants. In principle, all the amine oxides found in the prior art for this purpose, i.e. compounds that have the formula R¹R²R³NO, where each of R¹, R² and R³, independently of one another, are an optionally substituted C₁-C₃₀ hydrocarbon chain, can be used in this respect. Amine oxides that are particularly preferably used are those in which R¹ is C₁₂-C₁₈ alkyl and R² and R³ are, independently of one another, each C₁-C₄ alkyl, in particular C₁₂-C₁₈ alkyl dimethyl amine oxides. Examples of representatives of suitable amine oxides are N-cocalkyl-N,N-dimethyl amine oxide, N-tallow alkyl-N,N-dihydroxyethyl amine oxide, myristyl-/cetyldimethyl amine oxide or lauryl dimethyl amine oxide.

Suitable alkyl(poly)glycosides are, for example, those of the formula R¹O-[G]ₚ, in which R¹ is a linear or branched alkyl having 12 to 16 carbon atoms, G is a sugar functional group having 5 or 6 carbon atoms, in particular glucose, and the index p is 1 to 10.

Particularly preferred microemulsions according to the invention contain a surfactant system which contains at least one anionic surfactant in addition to at least one non-ionic surfactant. It has been found that this surfactant combination further increases the amount of the above-mentioned thickening agent stably incorporated into the microemulsion.

The term “anionic surfactant,” as used herein, includes all surfactants having negatively charged functional groups, in particular sulfate, sulfonate and carboxylate groups, and comprises, for example, alkyl sulfates, olefin sulfonates, alkane sulfonates, alkyl ether sulfates and alkylbenzene sulfonates.

In different embodiments of the invention, in particular dialkyl sulfosuccinates and the salts thereof, preferably alkali metal salts and ammonium salts, particularly preferably sodium salts and ammonium salts, and polyalkylene oxide-unit-containing derivatives thereof, are used as anionic surfactants. In this case, the alkyl functional groups can each independently be linear or branched and contain 6 to 22, preferably 6-12, carbon atoms. Preferred alkyl functional groups are independently selected from 1-hexyl, 3,5,5-trimethyl-1-hexyl, isooctyl, such as 2-ethyl-1-hexyl, 6-methyl-1-heptyl, 2-methyl-1-heptyl, 2-propyl-1-pentyl, 2,4,4-trimethyl-1-pentyl, 1-ethyl-2-methyl-1-pentyl and 1,4-dimethyl-1-hexyl. Surfactants of this kind include, for example, those of the formula

R¹—(OCHR³—CH₂)ₘ—O—C(O)—CH(SO₃X)—CH₂—C(O)—O—(CH₂—CHR³O)ₙ—R²

in which R¹ and R² independently represent linear or branched alkyl functional groups having 6 to 22 carbon atoms, in particular 6 to 12 carbon atoms, which are preferably selected from 1-hexyl, 3,5,5-trimethyl-1-hexyl, isooctyl, such as 2-ethyl-1-hexyl, 6-methyl-1-heptyl, 2-methyl-1-heptyl, 2-propyl-1-pentyl, 2,4,4-trimethyl-1-pentyl, 1-ethyl-2-methyl-1-pentyl and 1,4-dimethyl-1-hexyl;
each R³ independently represents H, CH₃ or CH₂CH₃, in particular H;
each n independently represents O or an integer from 1 to 30, preferably O;
X represents a monovalent cation or the nth part of an n-valent cation, in this case the alkali metal ions, which include Na⁺ or K⁺, being preferred, Na⁺ being extremely preferred, as well as NH₄⁺, ½ Zn²⁺, ½ Mg²⁺, ½ Ca²⁺, ½ Mn²⁺, and mixtures thereof.

Of the above-mentioned surfactants, particularly preferred are those in which R¹ and R² are identical and are selected from branched alkyl functional groups, including, but not restricted to, 3,5,5-trimethyl-1-hexyl, isooctyl, such as 2-ethyl-1-hexyl, 6-methyl-1-heptyl, 2-methyl-1-heptyl, 2-propyl-1-pentyl, 2,4,4-trimethyl-1-pentyl, 1-ethyl-2-methyl-1-pentyl and 1,4-dimethyl-1-hexyl, in particular isooctyl, such as 2-ethyl-1-hexyl, 6-methyl-1-heptyl and 2-methyl-1-heptyl. In surfactants of this kind, R³ is preferably H and n is 0. Very particularly preferred are sodium bis-(isooctyl)sulfosuccinate, such as sodium bi s-(2-ethyl-1-hexyl)sulfosuccinate, sodium bis-(6-methyl-1-heptyl)sulfosuccinate and sodium bis-(2-methyl-1-heptyl)sulfosuccinate.

Alternatively, the corresponding acids can also be used.

Dialkyl sulfosuccinates of formula (A-1) or combinations thereof are very particularly preferred,

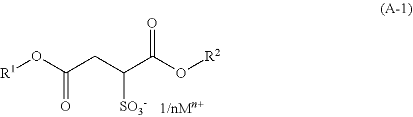

in which the functional groups R¹ and R², independently of one another, are each linear or branched and contain 6 to 22 carbon atoms, preferably 6 to 12 carbon atoms, and are particularly preferably selected from 1-hexyl, 3,5,5-trimethyl-1-hexyl, 2-ethyl-1-hexyl, 6-methyl-1-heptyl, 2-methyl-1-heptyl, 2-propyl-1-pentyl, 2,4,4-trimethyl-1-pentyl, 1-ethyl-2-methyl-1-pentyl, and 1,4-dimethyl-1-hexyl, and 1/n Mnⁿ⁺ is an equivalent of an n-valent cation.

Additionally or alternatively, the surfactant system can contain additional anionic surfactants. In different embodiments, these additional anionic surfactants are selected from alkylbenzene sulfonates, olefin sulfonates, alkane sulfonates, alkyl ester sulfonates, alk(en)yl sulfates, alkyl ether sulfates, N-acyl taurides, polyether sulfonates, and mixtures of two or more of these anionic surfactants. Other suitable anionic surfactants are soaps, i.e. salts of fatty acids, in particular the Na or K salts of fatty acids. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut, palm kernel, olive oil or tallow fatty acids.

Surfactants of the sulfonate type that can be used are preferably alkylbenzene sulfonates, olefin sulfonates, i.e. mixtures of alkene and hydroxyalkane sulfonates, and disulfonates, as obtained, for example, from C₁₂₋₁₈ monoolefins having a terminal or internal double bond by way of sulfonation with gaseous sulfur trioxide and subsequent alkaline or acid hydrolysis of the sulfonation products. C₁₂₋₁₈ alkane sulfonates and the esters of α-sulfofatty acids (ester sulfonates) are also suitable, for example the α-sulfonated methyl esters of hydrogenated coconut fatty acids, palm kernel fatty acids or tallow fatty acids, and taurides and polyether sulfonates.

Alkylbenzene sulfonates are preferably selected from linear or branched alkylbenzene sulfonates of formula

R—SO₃⁻X⁺

In this formula, R represents a linear or branched, unsubstituted alkyl aryl functional group. X represents a monovalent cation or the nth part of an n-valent cation, in this case the alkali metal ions, which include Na⁺ or K⁺, being preferred, Na⁺ being most preferred. Further cations x⁺may be selected from NH₄⁺, ½ Zn²⁺, ½ Mg²⁺, ½ Ca²⁺, ½ Mn²⁺, and mixtures thereof.

“Alkylaryl,” as used herein, refers to organic functional groups that consist of an alkyl functional group and an aromatic functional group. Typical examples of functional groups of this kind include, but are not restricted to, alkylbenzene functional groups, such as benzyl, butylbenzene functional groups, nonylbenzene functional groups, decylbenzene functional groups, undecylbenzene functional groups, dodecylbenzene functional groups, tridecylbenzene functional groups and the like.

In different embodiments, surfactants of this kind are selected from linear or branched alkylbenzene sulfonates of the formula

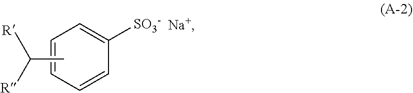

in which R′ and R″ together contain 8 to 19, preferably 8 to 15, and in particular 8 to 12, C atoms. A very particularly preferred representative is sodium dodecylbenzene sulfonate.

Other anionic surfactants that can be used are alkyl ester sulfonates, in particular those of the formula

R³—CH(SO₃⁻X⁺)—C(O)—O—R²

In this formula, R¹ represents a linear or branched, substituted or unsubstituted alkyl functional group, preferably a linear, unsubstituted alkyl functional group. Preferred functional groups R¹ are selected from nonyl, decyl, undecyl, dodecyl, tridecyl, tetradecyl, pentadecyl, hexadecyl, heptadecyl, octadecyl, nonadecyl, eicosyl, heneicosyl functional groups and mixtures thereof, the representatives having an odd number of C atoms being preferred. Particularly preferred functional groups R¹—CH are derived from C₁₂-C₁₈ fatty acids, for example from lauryl, myristyl, cetyl or stearyl acid. R² represents a linear or branched, substituted or unsubstituted alkyl functional group, preferably a linear, unsubstituted alkyl functional group. Preferred functional groups R² are C₁₋₆ alkyl functional groups, in particular methyl (=methyl ester sulfonates). X represents a monovalent cation or the nth part of an n-valent cation, in this case the alkali metal ions, which include Na⁺ or K⁺, being preferred, Na⁺ being most preferred. Further cations x⁺ may be selected from NH₄⁺, ½ Zn²⁺, ½ Mg²⁺, ½ Ca²⁺, ½ Mn²⁺, and mixtures thereof.

The secondary alkane sulfonates are also suitable as anionic surfactants. Said sulfonates have, for example, the formula

R¹CH(SO₃⁻X⁺)R²

in which each of R¹ and R² is independently a branched or linear alkyl having 1 to 20 carbon atoms and, together with the carbon atom to which they are bonded, form a linear or branched alkyl, preferably having 10 to 30 carbon atoms, preferably having 10 to 20 carbon atoms, and x⁺ is selected from the group Na⁺, K⁺, NH₄⁺, ½ Zn²⁺, ½ Mg²⁺, ½ Ca²⁺, ½ Mn²⁺ and mixtures thereof, preferably Na⁺.

In different preferred embodiments, the at least one secondary alkane sulfonate has the following formula

H₃C—(CH₂)ₙ—CH(SO₃⁻X⁺)—(CH₂)ₘ—CH₃

in which m and n represent, independently of one another, an integer between 0 and 20.

Preferably, m+n is an integer between 7 and 17, preferably 10 to 14, and x⁺ is selected from the group Na⁺, K⁺, NH₄⁺, ½ Zn²⁺, ½ Mg²⁺, ½ Ca²⁺, ½ Mn²⁺ and mixtures thereof, preferably Na⁺. In a particularly preferred embodiment, the at least one secondary alkane sulfonate is secondary C₁₄₋₁₇ sodium alkane sulfonate. A secondary C₁₄₋₁₇ sodium alkane sulfonate of this kind is marketed, for example, by Clariant under the trade name “Hostapur SAS60.”

Suitable taurides are those of the general formula

R—C(O)—N(CH₃)—CH₂CH₂—SO₃⁻X⁺

in which R is a linear or branched, preferably an odd-numbered, alkyl functional group having 6 to 30, preferably 7 to 17, carbon atoms.

Other suitable anionic surfactants are the polyethersulfonates, described in EP 2203419 A1, of the formula

R¹—O—(CH₂—CHR²O)ₙCH₂—C(O)—CH₂SO₃⁻X⁺

in which R¹ represents a straight-chain, branched, saturated or unsaturated aliphatic and/or aromatic hydrocarbon functional group having 6 to 30 carbon atoms, R², independently of one another, represents each of the k alkoxy units for hydrogen or a straight-chain, branched, aliphatic or aromatic hydrocarbon functional group having 1 to 10 carbon atoms, n represents a number from 0 to 35, and x⁺ represents H⁺, Na⁺, K⁺, NH₄⁺, ½ Zn²⁺, ½ Mg²⁺, ½ Ca²⁺, ½ Mn²⁺ and mixtures thereof, preferably Na⁺.

Particularly preferably, alkyl ether sulfates of formula (A-3)

R¹—O—(AO)—SO₃⁻X⁺ (A-3)

are suitable. In formula (A-3), R¹ represents a linear or branched, substituted or unsubstituted (C₁₀-C₂₀) alkyl functional group, preferably a linear, unsubstituted alkyl functional group, particularly preferably a fatty alcohol functional group. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

According to formula (A-3), AO represents an ethylene oxide (EO) or propylene oxide (PO) group, preferably an ethylene oxide group. According to formula (A-3), the index n represents an integer from 1 to 50, preferably from 1 to 20, and in particular from 2 to 10. Very particularly preferably, n represents the numbers 2, 3, 4, 5, 6, 7 or 8. According to formula (A-3), X represents a monovalent cation or the nth part of an n-valent cation, in this case the alkali metal ions, which include Na⁺ or K⁺, being preferred, Na⁺ being extremely preferred. Other cations X⁺ may be selected from NH₄⁺, ½ Zn²⁺, ½ Mg²⁺, ½ Ca²⁺, ½ Mn²⁺, and mixtures thereof. Particularly preferred washing agents contain an alkyl ether sulfate selected from fatty alcohol ether sulfates of the formula

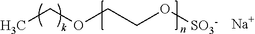

where k=11 to 19, and n=2, 3, 4, 5, 6, 7 or 8. Very particularly preferred representatives are Na-C₁₂₋₁₄ fatty alcohol ether sulfates having 2 EO (k=11-13, n=2). The degree of ethoxylation indicated represents a statistical average that can correspond to an integer or a fractional number for a specific product. The degrees of alkoxylation indicated represent statistical averages that can correspond to an integer or a fractional number for a specific product. Preferred alkoxylates/ethoxylates have a narrowed homolog distribution (narrow range ethoxylates, NRE).

The salts of the sulfuric acid half-esters of C₁₂-C₁₈ fatty alcohols, for example from coconut fatty alcohol, tallow fatty alcohol, lauryl, myristyl, cetyl or stearyl alcohol, or of C₁₀-C₂₀ oxo alcohols and the half-esters of secondary alcohols having this chain length are preferred as alk(en)yl sulfates. From a washing perspective, the C₁₂-C₁₆ alkyl sulfates, C₁₂-C₁₅ alkyl sulfates and C₁₄-C₁₅ alkyl sulfates are preferred. 2,3-alkyl sulfates are also suitable anionic surfactants. Alkyl sulfates of the following formula can therefore generally be used:

R¹—O—SO₃⁻X⁺ (A-4).

In this formula (A-4), R¹ represents a linear or branched, substituted or unsubstituted alkyl functional group, preferably a linear, unsubstituted alkyl functional group, particularly preferably a fatty alcohol functional group. Preferred functional groups R² are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols. X represents a monovalent cation or the nth part of an n-valent cation, in this case the alkali metal ions, which include Na⁺ or K⁺, being preferred, Na⁺ being extremely preferred. Further cations x⁺may be selected from NH₄⁺, ½ Zn²⁺, ½ Mg²⁺, ½ Ca²⁺, ½ Mn²⁺, and mixtures thereof.

In different embodiments, these surfactants are selected from fatty alcohol sulfates of the formula

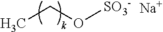

where k=11 to 19. Very particularly preferred representatives are Na-C₁₂₋₁₄ fatty alcohol sulfates (k=11-13).

The above-mentioned anionic surfactants including the fatty acid soaps can also be present as acids, but are present preferably in the form of their sodium, potassium, magnesium or ammonium salts. Sodium salts and/or ammonium salts are particularly preferred. Amines that can be used for neutralization are preferably choline, triethylamine, monoethanolamine, diethanolamine, triethanolamine, methylethylamine or a mixture thereof, monoethanolamine being preferred.

Very particularly preferred microemulsions are characterized in that the at least one anionic surfactant is selected from C₉-C₁₅ alkylbenzene sulfonate, C₁₀-C₂₀ alkylether sulfate, (C₆-C₂₂) dialkyl sulfosuccinates, or mixtures thereof. In this case, these anionic surfactants are in turn very particularly preferably selected from surfactants of the formulas described above, in particular formulas (A-1), (A-2), (A-3) and (A-4).

In preferred embodiments of the invention, the surfactant system comprises at least one alkyl ether as the non-ionic surfactant, preferably a C₈₋₂₀ fatty alcohol alkoxylate having 1 to 10 E0 and 0 to 10 PO and at least one dialkyl sulfosuccinate (as described above) as the anionic surfactant. In this case, the weight ratio of anionic to non-ionic surfactant is 100:1 to 1:100, preferably 25:1 to 1:25, 1:2 to 1:10 in specific particularly preferred embodiments.

Very particularly preferred are microemulsions according to the invention, containing, in each case based on the total weight of the emulsion,

a) a total amount from 5 to 20 wt. % water as the liquid phase,
b) a total amount from 40 wt. % to 90 wt. % of at least one non-polymeric, organic thickening agent having a molecular weight in the range from 100 g/mol to 1500 g/mol as the emulsified phase, and
c) a surfactant system, containing, in each case based on the weight of the microemulsion, a total amount of

c1) 5 to 15 wt. % of at least one C₈-C₂₀ fatty alcohol alkoxylate having 1 to 10 EO and 0 to 10 PO as the non-ionic surfactant and

c2) 10 to 15 wt. % of at least one dialkyl sulfosuccinate (as described above) as the anionic surfactant,

the weight ratio of c1) and c2) being in a weight ratio range from 2:1 to 1:2.

In preferred embodiments, the surfactant system contains an alkyl ether as the non-ionic surfactant, preferably a C₈-₂₀ fatty alcohol alkoxylate having 1 to 10 E0 and 0 to 10 PO, and at least one C₈-C₁₂ alkylbenzene sulfonate as the anionic surfactant.

Very particularly preferred are microemulsions according to the invention in the form of an oil-in-water emulsion, containing, in each case based on the total weight of the emulsion,

a) a total amount from 5 to 50 wt. %, in particular 5 to 30 wt. %, water as the liquid phase,
b) a total amount from 2.5 wt. % to 90 wt. %, in particular 20 to 90 wt. %, of at least one non-polymeric, organic thickening agent having a molecular weight in the range from 100 g/mol to 1500 g/mol as the emulsified phase, and
c) a surfactant system, containing, in each case based on the weight of the microemulsion, a total amount of

c1) 3 to 40 wt. % of at least one C₈₋₂₀ fatty alcohol alkoxylate having 1 to 10 EO and 0 to 10 PO as the non-ionic surfactant and

c2) 10 to 40 wt. % of at least one C₈-C₁₂ alkylbenzene sulfonate as the anionic surfactant, the weight ration of c1) and c2) being in a weight ratio range from 15:1 to 1:15.

The microemulsion according to the invention necessarily contains at least one liquid phase. This liquid phase is different from the surfactant system and the above-mentioned thickening agent. In a preferred oil-in-water emulsion, the at least one liquid phase is water.

In the microemulsion according to the invention, the liquid phase is preferably contained in a total amount between 0 and 50 wt. %, in particular from 10 to 40 wt. %.

It is easy to dose the microemulsions according to the invention. Said microemulsions have a preferred viscosity of 10⁻¹ to 10⁴ mPa*s.

A second subject matter of the invention is a method for preparing the microemulsions of the first subject matter of the invention. Said microemulsions are obtained using a method for preparing a microemulsion existing at a temperature T1, in which

i) based on the weight of the microemulsion, a total amount from 10 wt. % to 99.0 wt. % of at least one non-polymeric, organic thickening agent having a molecular weight from 100 g/mol to 1500 g/mol as the first liquid phase is mixed with at least one liquid as the second liquid phase, at least one surfactant C1 and at least one non-ionic surfactant C2, thus producing a cloudy mixture, and
ii) the mixture is brought to a temperature T1 and further mixed thoroughly,
with the proviso that the temperature T1 is at least as high as the melting point of at least one above-mentioned low-molecular-weight thickening agent from step i) and a microemulsion is obtained.

For this purpose, at least one first surfactant C1, it also being possible for said at least one first surfactant to be a mixture of a plurality of surfactants, is provided in a concentration that is below the fishtail point, and a second amphiphile/surfactant C2 (which is different from the at least one surfactant C1) is added at a constant temperature and constant water:oil ratio. The surfactant C1 is preferably at least one non-ionic surfactant and/or at least one anionic surfactant and the surfactant C2 is preferably at least one non-ionic surfactant.

The preferred features of the thickening agent according to the invention, of the surfactant system according to the invention and of the additional emulsion features (fishtail point, emulsion structure etc.) of the first subject matter of the invention also apply, mutatis mutandis, to the second subject matter of the invention.

A method that is preferred according to the invention is characterized in that the at least one surfactant C2 is mixed in only after step ii).

The temperature T1 is at least as high as the melting point of at least one above-mentioned low-molecular-weight thickening agent from step i). The aim is to completely convert said thickening agent into a liquid phase. In this case, it is possible that in a thickening-agent mixture, the solid thickening agents dissolve in the at least one liquid thickening agent. On the other hand, it is also possible that in a mixture of thickening agents, the temperature T1 is selected such that it assumes at least the value of the highest melting point of the thickening agent used. The temperature T1 of the method according to the invention is preferably in a temperature range from 20 to 100° C., more preferably between 30° C. and 100° C., even more preferably from 40 to 98° C., particularly preferably between 40° C. and 95° C., very particularly preferably from 70° C. to 90° C., yet more preferably from 75 to 95° C.

A third subject matter of the invention is a liquid surfactant composition, in particular a liquid washing agent, which is obtained by mixing a total amount, based on the total weight of the liquid surfactant composition, from 0.001 wt. % to 5 wt. % of at least one microemulsion of the first subject matter of the invention with a composition containing water and at least one surfactant, with the provisions that the liquid surfactant composition
contains a total amount from 5 to 80 wt. % of at least one surfactant and
has a yield point, in particular from 0.001 to 6 Pa, particularly preferably from 0.1 to 3 Pa.

The total amount of the above-mentioned non-polymeric, organic thickening agent introduced by the microemulsion according to the invention is, based on the total weight of the liquid surfactant composition, preferably 0.001 wt. % to 5.0 wt. %, particularly preferably 0.01 wt. % to 3.0 wt. %.

In order to develop the cleaning or washing performance, the liquid surfactant compositions according to the invention contain at least one surfactant, particularly preferably a mixture of a plurality of surfactants of different substance classes. All the surfactants mentioned in the first subject matter of the claim are suitable.

In this case, it is particularly preferred for the invention if the total amount of surfactant is from 5.0 to 70 wt. %, preferably 8.0 to 60.0 wt. %, more preferably from 10.0 to 50.0 wt. %, particularly preferably from 15.0 to 45.0 wt. %, in each case based on the total weight of the liquid surfactant composition.

According to the invention, preferably at least one anionic surfactant is used as the surfactant.

All anionic surface-active substances are suitable for use as anionic surfactants in the liquid surfactant compositions according to the invention. These are characterized by a water-solubilizing, anionic group such as a carboxylate, sulfate, sulfonate or phosphate group and a lipophilic alkyl group having approximately 8 to 30 C atoms. In addition, glycol ether or polyglycol ether groups, ester, ether and amide groups, and hydroxyl groups can be contained in the molecule. Suitable anionic surfactants are preferably present in the form of sodium, potassium and ammonium and mono-, di- and trialkanolammonium salts having 2 to 4 carbon atoms in the alkanol group.

Preferred liquid surfactant compositions according to the invention contain, based on the total weight of the composition, anionic surfactant in a total amount from 5.0 to 35.0 wt. %, preferably from 8.0 to 30.0 wt. %, particularly preferably from 10.0 to 25.0 wt. %.

Preferred anionic surfactants in the liquid surfactant compositions according to the invention are alkyl sulfates, alkyl polyglycol ether sulfates, and alkylbenzene sulfonates, each having 10 to 18 C atoms in the alkyl group and up to 12 glycol ether groups in the molecule.

Preferred liquid surfactant compositions according to the invention that are used according to the invention contain at least one surfactant of formula (A-3)

R¹—O—(AO)ₙ—SO₃⁻X⁺. (A-3)

In this formula, R¹ represents a linear or branched, substituted or unsubstituted alkyl, aryl or alkylaryl functional group, preferably a linear, unsubstituted alkyl functional group, particularly preferably a fatty alcohol functional group. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

AO represents an ethylene oxide (EO) or propylene oxide (PO) group, preferably an ethylene oxide group. The index n represents an integer from 1 to 50, preferably from 1 to 20, and in particular from 2 to 10. Very particularly preferably, n represents the numbers 2, 3, 4, 5, 6, 7 or 8. X represents a monovalent cation or the nth part of an n-valent cation, in this case the alkali metal ions, which include Na⁺ or K⁺, being preferred, Na⁺being most preferred. Further cations X⁺ may be selected from NH₄⁺, ½ Zn²⁺, ½ Mg²⁺, ½ Ca²⁺, ½ Mn²⁺, and mixtures thereof.

In summary, particularly preferred liquid surfactant compositions according to the invention contain at least one anionic surfactant, selected from fatty alcohol ether sulfates of formula A-3a

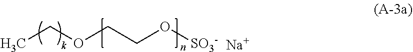

where k=11 to 19, and n=2, 3, 4, 5, 6, 7 or 8. Very particularly preferred representatives are Na-C₁₂₋₁₄ fatty alcohol ether sulfates having 2 EO (k=11-13, n=2 in formula A-3a).

Preferred liquid surfactant compositions according to the invention contain, based on the total amount of the composition, 1.0 to 15 wt. %, preferably 2.5 to 12.5 wt. %, more preferably 5.0 to 10.0 wt. %, fatty alcohol ether sulfate(s) (in each case in particular of formula A-3a).

Other preferred liquid surfactant compositions according to the invention additionally or alternatively (in particular additionally) contain at least one surfactant of formula (A-5)

R³-A-SO₃⁻1/nYⁿ⁺ (A-5)

In this formula, R³ represents a linear or branched, substituted or unsubstituted alkyl functional group, a linear or branched, substituted or unsubstituted aryl functional group, or a linear or branched, substituted or unsubstituted alkylaryl functional group, and the group -A- represents —O— or a chemical bond. In other words, the above formula can describe sulfate surfactants (A═O) or sulfonate surfactants (A=chemical bond). Depending on the selection of the group A, specific functional groups R³ are preferred. In the sulfate surfactants (A═O), R³ preferably represents a linear, unsubstituted alkyl functional group, particularly preferably for a fatty alcohol functional group. Preferred functional groups le are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups le are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols. 1/n Yⁿ⁺ represents a monovalent cation or the nth part of an n-valent cation, in this case the alkali metal ions, which include Na⁺ or K⁺ , being preferred, Na⁺being extremely preferred. Further cations Y⁺ may be selected from NH₄⁺, ½ Zn²⁺, ½ Mg²⁺, ½ Ca²⁺, ½ Mn²⁺, and mixtures thereof.

Surfactants of this kind are selected from fatty alcohol sulfates of formula A-5a

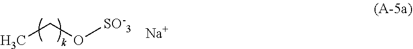

where k=11 to 19. Very particularly preferred representatives are Na-C₁₂₋₁₄ fatty alcohol sulfates (k=11-13 in formula A-5a).

More preferred liquid surfactant compositions according to the invention contain, based on the total amount of the compositions, 1.0 to 25.0 wt. %, preferably 2.5 to 20.5 wt. %, more preferably 5.0 to 20.0 wt. %, surfactant from the group comprising C₉₋₁₃ alkylbenzene sulfonate, (C₈-C₂₂) olefin sulfonate, C₁₂₋₁₈ alkane sulfonate, (C₈-C₂₂) ester sulfonate, (C₈-C₂₂) alk(en)yl sulfate, and mixtures thereof (in particular from the group of C₉₋₁₃ alkylbenzene sulfonates, preferably the group according to formula (A-2)).

In the sulfonate surfactants (A=chemical bond), which are preferred over the sulfate surfactants of the above formula, R³ preferably represents a linear or branched unsubstituted alkylaryl functional group. Here, too, X represents a monovalent cation or the nth part of an n-valent cation, in this case the alkali metal ions, which include Na⁺ or K⁺, being preferred, Na⁺ being extremely preferred. Further cations X⁺ may be selected from NH₄⁺, ½ Zn²⁺, ½ Mg²⁺, ½ Ca²⁺, ½ Mn²⁺, and mixtures thereof.

Such extremely preferred surfactants are selected from linear or branched alkylbenzene sulfonates of formula A-2

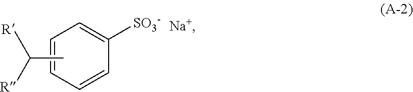

in which R′ and R″ together contain 9 to 19, preferably 11 to 15, and in particular 11 to 13, C atoms. A very particularly preferred representative can be described by formula A-2a:

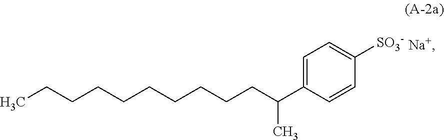

It has proven advantageous for cold-wash performance if the liquid surfactant compositions according to the invention additionally contain soap(s) as the anionic surfactant. Soaps are the water-soluble sodium or potassium salts of saturated or unsaturated fatty acids having 10 to 20 carbon atoms, of resin acids of rosin (yellow resin soaps), and of naphthenic acids, which are used as solid or half-solid mixtures principally for washing and cleaning purposes. Sodium or potassium salts of saturated and unsaturated fatty acids having 10 to 20 carbon atoms, in particular having 12 to 18 carbon atoms, are preferred soaps according to the invention. In this case, particularly preferred compositions are characterized in that they contain, based on their weight, 0.1 to 6 wt. %, particularly preferably 0.2 to 4.5 wt. %, very particularly preferably 0.3 to 4.1 wt. %, soap(s).

For an improved solution to the technical problem, it is very particularly preferred according to the invention to use a combination of

at least one fatty alcohol ether sulfate of formula A-3a

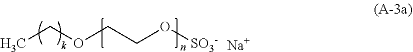

where k=11 to 19, n=2, 3, 4, 5, 6, 7 or 8 (particularly preferred representatives are Na-C₁₂₋₁₄ fatty alcohol ether sulfates with 2 EO (k=11-13, n=2 in formula A-3)), and

at least one linear or branched alkylbenzene sulfonate of formula A-2

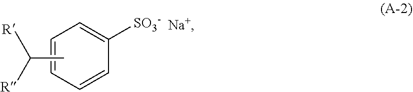

in which R′ and R″ together contain 9 to 19, preferably 11 to 15, and in particular 11 to 13, C atoms (in particular of the above formula (A-2a)),
in the surfactant compositions according to the invention. Preferred surfactant compositions of this embodiment are optionally preferably characterized in that they contain one or more soaps (preferably, based on their weight, 0.1 to 6 wt. %, particularly preferably 0.2 to 4.5 wt. %, very particularly preferably 0.3 to 4.1 wt. %, soap(s)).

In addition to or instead of the anionic surfactant(s), the liquid surfactant compositions according to the invention preferably contain at least one non-ionic surfactant.

Particularly preferably, the surfactant compositions contain at least one non-ionic surfactant from the group of (C₈-C₂₂) fatty alcohol ethoxylates, as these surfactants provide high-performing compositions even at low washing temperatures and have excellent stability at low temperatures in the case of liquid preparations.

Correspondingly, particularly preferred surfactant compositions additionally contain at least one non-ionic surfactant of the formula

R²—O—(AO)ₘ—H,

in which
R² represents a linear or branched, substituted or unsubstituted alkyl, aryl or alkylaryl functional group,
AO represents an ethylene oxide (EO) or propylene oxide (PO) group,
m represents an integer from 1 to 50.

In the above-mentioned formula, R² represents a linear or branched, substituted or unsubstituted alkyl functional group, a branched, substituted or unsubstituted aryl functional group, or a branched, substituted or unsubstituted alkylaryl functional group, preferably a linear, unsubstituted alkyl functional group, particularly preferably a fatty alcohol functional group. Preferred functional groups R² are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R² are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

AO represents an ethylene oxide (EO) or propylene oxide (PO) group, preferably an ethylene oxide group. The index m represents an integer from 1 to 50, preferably from 1 to 20, and in particular from 2 to 10. Very particularly preferably, m represents the numbers 2, 3, 4, 5, 6, 7 or 8.

In summary, particularly preferred surfactants are selected from fatty alcohol ethoxylates of formula A-6

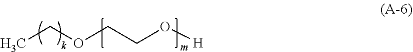

where k=11 to 19, and m=2, 3, 4, 5, 6, 7 or 8. Very particularly preferred representatives are C₁₂₋₁₈ fatty alcohols with 7 EO (k=11-17, m=7 in formula A-6).

Particularly preferred compositions contain non-ionic surfactants in specific amounts. Extremely preferred liquid surfactant compositions according to the invention are characterized in that the total amount of non-ionic surfactants is, based on the weight of the compositions, 1.0 to 25 wt. %, preferably 2.5 to 20.0 wt. %, more preferably 5.0 to 18.0 wt. %.

More preferred compositions contain, based on the total amount of the compounds, 1.0 to 25 wt. %, preferably 2.5 to 20.0 wt. %, more preferably 5.0 to 18.0 wt. %, fatty alcohol ethoxylate(s) (in particular of formula (A-6)).

Preferred liquid surfactant compositions according to the invention contain, based on the total weight of the composition,

anionic surfactant in a total amount from 1.0 to 35.0 wt. %, preferably from 5.0 to 30.0 wt. %, particularly preferably from 10.0 to 25.0 wt. %, and

non-ionic surfactant in a total amount from 1.0 to 25 wt. %, preferably 2.5 to 20.0 wt. %, more preferably 5.0 to 18.0 wt. %.

In this case, it is in turn preferred to use the preferred surfactants (most preferably in the amounts characterized as preferred). The amount of the specific anionic and non-ionic surfactants is, in this case, to be selected such that the previously mentioned total amount of anionic surfactant and the previously defined total amount of non-ionic surfactant are maintained.

According to a particularly preferred embodiment, compounds are preferred which contain

i) at least one anionic surfactant of formula R¹—O—(AO)ₙ—-SO₃⁻X⁺, and
ii) at least one anionic surfactant of formula A-2

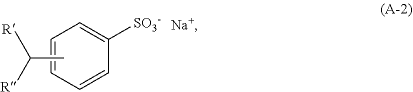

and
iii) at least one non-ionic surfactant of formula R²—O—(AO)ₘ—H, in which
R¹ represents a linear or branched, substituted or unsubstituted alkyl, aryl or alkylaryl functional group,
R′ and R″ together contain 9 to 19, preferably 11 to 15 and in particular 11 to 13, C atoms,
AO independently represents an ethylene oxide (EO) or propylene oxide (PO) group,
n and m represent, independently of one another, integers from 1 to 50,
X represents a monovalent cation or the nth part of an n-valent cation.

Surfactants i) and ii) have been described above as preferred surfactants a) having formulas (A-3) and (A-2a) and surfactant iii) has been described as a preferred surfactant having formula (A-6). In this case, preferred compositions of this embodiment are in turn characterized in that they additionally contain at least one soap.

According to a very particularly preferred embodiment, compounds are preferred which contain, based on the weight of the composition,

i) at least one anionic surfactant, in a total amount from 1.0 to 15 wt. %, preferably 2.5 to 12.5 wt. %, more preferably 5.0 to 10.0 wt. %, of formula R¹—O—(AO)ₙ—SO₃⁻X⁺, and
ii) at least one anionic surfactant, in a total amount from 1.0 to 25 wt. %, preferably 2.5 to 20.5 wt. %, more preferably 5.0 to 20.0 wt. %, of formula A-2

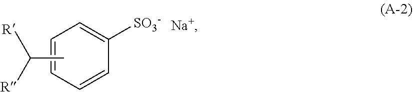

and
iii) at least one non-ionic surfactant, in a total amount from 1.0 to 25 wt. %, preferably 2.5 to 20.0 wt. %, more preferably 5.0 to 18.0 wt. %, of formula R²—O—(AO)ₘ—H,
in which
R¹ represents a linear or branched, substituted or unsubstituted alkyl, aryl or alkylaryl functional group,
R′ and R″ together contain 9 to 19, preferably 11 to 15 and in particular 11 to 13, C atoms,
AO independently represents an ethylene oxide (EO) or propylene oxide (PO) group,
n and m represent, independently of one another, integers from 1 to 50,
X represents a monovalent cation or the nth part of an n-valent cation.

In this case, preferred surfactant compositions are in turn characterized in that they contain, based on their weight, 1 to 6 wt. %, particularly preferably 0.2 to 4.5 wt. %, very particularly preferably 0.3 to 4.1 wt. %, soap(s).

The liquid surfactant compositions according to the invention can contain water as the solvent. Compositions that are preferred according to the invention contain water in a total amount from 1 to 55 wt. %, in particular from 2 to 50 wt. %, in each case based on the total weight of the composition.

In this case, it is preferable for the liquid surfactant composition to contain more than 5 wt. %, preferably more than 15 wt. % and particularly preferably more than 25 wt. %, very particularly preferably more than 40 wt. %, water, in each case based on the total amount of washing agent.

In this case, it is in turn particularly preferred if the washing agent contains less than 55 wt. %, preferably less than 50 wt. %, and particularly preferably less than 45 wt. %, water, in each based on the total amount of washing agent.

Liquid surfactant compositions are preferably characterized in that the weight ratio of the surfactant amount of the microemulsion to the total surfactant amount of the liquid surfactant composition is in a range of at most 1 to 2, particular of at most 1:30, particularly preferably of at most 1 to 100.

Very particularly preferred liquid surfactant compositions of the present invention additionally contain solid particles (also referred to as particles in the following) suspended in the liquid surfactant composition. Suspended solid particles of this type are understood to be solids that do not dissolve in the liquid phase of the surfactant composition according to the invention at 20° C. and are present as a separate phase.

The particles are preferably selected from polymers, pearlescing pigments, microcapsules, speckles, or mixtures thereof.

Within the meaning of the present invention, microcapsules include any type of capsule known to a person skilled in the art, but in particular core-shell capsules and matrix capsules. Matrix capsules are porous shaped bodies that have a structure similar to a sponge. Core-shell capsules are shaped bodies that have a core and a shell. Capsules that have an average diameter X_{50.3} (volume average) from 0.1 to 200 μm, preferably from 1 to 100 μm, more preferably from 5 to 80 μm, particularly preferably from 10 to 50 μm and in particular from 15 to 40 μm are suitable as microcapsules. The average particle size diameter X_{50.3} is determined by sieving or by means of a Camsizer particle size analyzer from Retsch.

The microcapsules of the invention preferably contain at least one active ingredient, preferably at least one odorant. This preferred microcapsules are perfume microcapsules.

In a preferred embodiment of the invention, the microcapsules have a semi-permeable capsule wall (shell).

A semi-permeable capsule wall within the meaning of the present invention is a capsule wall that is semi-permeable, i.e. continuously releases small quantities of the capsule core over time, without the capsules e.g. being destroyed or opened e.g. by tearing. These capsules continuously release small quantities of the active ingredient contained in the capsule, e.g. perfume, over a long period of time.

In another preferred embodiment of the invention, the microcapsules have an impermeable shell. An impermeable shell within the meaning of the present invention is a capsule wall that is substantially not permeable, i.e. releases the capsule core only by the capsule being damaged or opened. These capsules contain significant quantities of the at least one odorant in the capsule core, and therefore when the capsule is damaged or opened, a very intense fragrance is provided. The fragrance intensities thus achieved are generally so high that lower quantities of the microcapsules can be used in order to achieve the same fragrance intensity as for conventional microcapsules.

In a preferred embodiment of the invention, the surfactant composition according to the invention contains both microcapsules having a semipermeable shell and microcapsules having an impermeable shell. By using both types of capsule, a significantly improved fragrance intensity can be provided over the entire laundry cycle.

In another preferred embodiment of the invention, the composition according to the invention may also contain two or more different microcapsule types having semipermeable or impermeable shells.

High-molecular compounds are usually considered as materials for the shell of the microcapsules, such as protein compounds, for example gelatin, albumin, casein and others, cellulose derivatives, for example methylcellulose, ethylcellulose, cellulose acetate, cellulose nitrate, carboxymethylcellulose and others, and especially also synthetic polymers such as polyamides, polyethylene glycols, polyurethanes, epoxy resins and others. Preferably, melamine formaldehyde polymers, melamine urea polymers, melamine urea formaldehyde polymers, polyacrylate polymers or polyacrylate copolymers are used as the wall material, i.e. as the shell. Capsules according to the invention are for example, but not exclusively, described in US 2003/0125222 A1, DE 10 2008 051 799 A1 or WO 01/49817.

Preferred melamine formaldehyde microcapsules are prepared by melamine formaldehyde precondensates and/or the C₁-C₄ alkyl ether thereof in water, by the at least one odor modulator compound and optionally other ingredients, such as at least one odorant, condensing in the presence of a protective colloid. Suitable protective colloids are e.g. cellulose derivatives, such as hydroxyethyl cellulose, carboxymethyl cellulose and methylcellulose, polyvinylpyrrolidone, copolymers of N-vinylpyrrolidone, polyvinyl alcohols, partially hydrolyzed polyvinyl acetates, gelatin, arabic gum, xanthan gum, alginates, pectins, degraded starches, casein, polyacrylic acid, polymethacrylic acid, copolymerisates of acrylic acid and methacrylic acid, sulfonic-acid-group-containing water-soluble polymers having a content of sulfoethyl acrylate, sulfoethyl methacrylate or sulfopropyl methacrylate, and polymerisates of N-(sulfoethyl)-maleinimide, 2-acrylamido-2-alkyl sulfonic acids, styrene sulfonic acids and formaldehyde and condensates of phenol sulfonic acids and formaldehyde.

It is preferable for the surface of the microcapsules used according to the invention to be coated entirely or in part with at least one cationic polymer. Accordingly, at least one cationic polymer from polyquaternium-1, polyquaternium-2, polyquaternium-4, polyquaternium-5, polyquaternium-6, polyquaternium-7, polyquaternium-8, polyquaternium-9, polyquaternium-10, polyquaternium-11, polyquaternium-12, polyquaternium-13, polyquaternium-14, polyquaternium-15, polyquaternium-16, polyquaternium-17, polyquaternium-18, polyquaternium-19, polyquaternium-20, polyquaternium-22, polyquaternium-24, polyquaternium-27, polyquaternium-28, polyquaternium-29, polyquaternium-30, polyquaternium-31, polyquaternium-32, polyquaternium-33, polyquaternium-34, polyquaternium-35, polyquaternium-36, polyquaternium-37, polyquaternium-39, polyquaternium-43, polyquaternium-44, polyquaternium-45, polyquaternium-46, polyquaternium-47, polyquaternium-48, polyquaternium-49, polyquaternium-50, polyquaternium-51, polyquaternium-56, polyquaternium-57, polyquaternium-61, polyquaternium-69 or polyquaternium-86 is suitable as a cationic polymer for coating the microcapsules. Polyquaternium-7 is very particularly preferred. The polyquaternium nomenclature used in this application for the cationic polymers is taken from the declaration for cationic polymers according to the International Nomenclature of Cosmetic Ingredients (INCI declaration) for cosmetic raw materials.

Microcapsules that can preferably be used have an average diameter X_{50.3} in the range of 1 to 100 μm, preferably from 5 to 95 μm, in particular from 10 to 90 μm, for example from 10 to 80 μm.

The shell of the microcapsules surrounding the core or the (filled) cavity preferably has an average thickness in the range of approximately 5 to 500 nm, preferably of approximately 50 nm to 200 nm, in particular of approximately 70 nm to approximately 180 nm.

Pearlescing pigments are pigments that have a pearlescent shine. Pearlescing pigments consist of thin sheets that have a high refraction index, and partially reflect the light and are partially transparent to the light. The pearlescent shine is generated by interference of the light hitting the pigment (interference pigment). Pearlescing pigments are usually thin sheets of the above-mentioned material, or contain the above-mentioned material as thin, multilayered films or as components arranged in parallel in a suitable carrier material.

The pearlescing pigments that can be used according to the invention are either natural pearlescing pigments such as fish silver (guanine/hypoxanthine mixed crystals from fish scales) or mother of pearl (from ground seashells), monocrystalline, sheet-like pearlescing pigments such as bismuth oxychloride and pearlescing pigments with a mica base and a mica/metal oxide base. The latter pearlescing pigments are mica that has been provided with a metal oxide coating.

By using the pearlescing pigments in the suspension according to the invention, shine and optionally also color effects are achieved.

Pearlescing pigments with a mica base and mica/metal oxide base are preferred according to the invention. Mica is a phyllosilicate. The most important representatives of these silicates are muscovite, phlogopite, paragonite, biotite, lepidolite, and margarite. In order to produce the pearlescing pigments in conjunction with metal oxides, mica, primarily muscovite or phlogopite, is coated with a metal oxide. Suitable metal oxides are, inter alia, TiO₂, Cr₂O₃, and Fe₂O₃. Interference pigments and colored luster pigments are obtained as pearlescing pigments according to the invention by suitable coating. These pearlescing pigment types additionally have color effects in addition to a glittering optical effect. Furthermore, the pearlescing pigments that can be used according to the invention also contain a color pigment that does not derive from a metal oxide.

The grain size of the pearlescing pigments that are preferably used is preferably between 1.0 μm and 100 μm, particularly preferably between 10.0 and 60.0 μm at an average diameter X_{50.3} (volume average).

Within the meaning of the invention, speckles are understood to mean macroparticles, in particular macrocapsules, that have an average diameter X_{50.3} (volume average) of more than 300 μm, in particular from 300 to 1500 μm, preferably from 400 to 1000 μm.

Speckles are preferably matrix capsules. The matrix is preferably colored. The matrix is formed for example by gelation, polyanion-polycation interactions or polyelectrolyte-metal ion interactions, and this is well known in the prior art, just like the preparation of particles using these matrix-forming materials. An example of a matrix-forming material is alginate. In order to prepare alginate-based speckles, an aqueous alginate solution, optionally also containing the active ingredient or active ingredients to be included, is drop-formed and is then hardened in a precipitation bath containing Ca²⁺ ions or Al³⁺ ions. Alternatively, other matrix-forming materials may be used instead of alginate.

The liquid surfactant composition according to the invention may additionally contain other ingredients which further improve the practical and/or aesthetic properties of the composition, depending on the intended use.

The liquid surfactant compositions according to the invention contain preferably at least one enzyme. The enzyme may be a hydrolytic enzyme or another enzyme in a concentration that is expedient for the effectiveness of the agent. A preferred embodiment of the invention is therefore liquid surfactant compositions which comprise one or more enzymes. All enzymes which can develop catalytic activity in a washing or cleaning agent, in particular a protease, amylase, cellulase, hemicellulase, mannanase, tannanase, xylanase, xanthanase, xyloglucanase, β-glucosidase, pectinase, carrageenanase, perhydrolase, oxidase, oxidoreductase or a lipase, and mixtures thereof, can preferably be used as the enzymes. Enzymes are contained in the agent preferably in each case in an amount from 1×10⁻⁸ to 5 wt. % based on active protein and the total weight of the composition. Increasingly preferably, each enzyme is contained in liquid surfactant compositions according to the invention in an amount from 1×10⁻⁷ to 3 wt. %, from 0.00001 to 1 wt. %, from 0.00005 to 0.5 wt. %, from 0.0001 to 0.1 wt. %, and particularly preferably from 0.0001 to 0.05 wt. %, based on active protein. Particularly preferably, the enzymes exhibit synergistic cleaning performance against specific soiling or stains, i.e. the enzymes contained in the agent composition support one another in their cleaning performance. Synergistic effects can arise not only between different enzymes, but also between one or more enzymes and other ingredients of the agent according to the invention.

The amylase(s) is/are preferably an α-amylase. The hemicellulase is preferably a pectinase, a pullulanase and/or a mannanase. The cellulase is preferably a cellulase mixture or a single-component cellulase, preferably or predominantly an endoglucanase and/or a cellobiohydrolase. The oxidoreductase is preferably an oxidase, in particular a choline-oxidase, or a perhydrolase.

The proteases used are preferably alkaline serine proteases. They act as unspecific endopeptidases, i.e. they hydrolyze any acid amide bonds that are inside peptides or proteins and thereby remove protein-containing stains on the item to be cleaned. Their optimum pH is usually in the distinctly alkaline range. In preferred embodiments, the enzyme contained in the agent according to the invention is a protease.

The enzymes that are used in the present case may be naturally occurring enzymes or enzymes which have been changed by one or more mutations based on naturally occurring enzymes, in order to positively influence desired properties such as catalytic activity, stability or disinfecting performance.

The protein concentration can be determined using known methods, for example the BCA method (bicinchoninic acid; 2,2′-bichinolyl-4,4′-dicarboxylic acid) or the Biuret method. The active protein concentration is determined in this regard by titrating the active centers using a suitable irreversible inhibitor (for proteases: e.g. phenylmethylsulfonyl fluoride (PMSF)) and determining the functional group activity (cf. M. Sender et al., J. Am. Chem. Soc. 88, 24 (1966), pp. 5890-5913).

In the liquid surfactant compositions described herein, the enzymes to be used may furthermore be formulated together with accompanying substances, for example from fermentation. In the described formulations, the enzymes are preferably used as enzyme liquid formulation(s).

The enzymes are generally not provided in the form of pure protein, but rather in the form of stabilized, storable and transportable preparations. These ready-made preparations include, for example, solutions of the enzymes, advantageously maximally concentrated, low-moisture, and/or supplemented with stabilizers or other adjuvants.

The liquid surfactant composition according to the invention can further contain:
optional oils. In this case, oils are to be understood substantially as oils that cannot mix with water. They are used in particular for dissolving fatty stains. Alkanes can be used; biologically decomposable oils with ether or ester groups are preferred. It is also possible to use terpenes. Preferred oils are dialkyl ethers having 6 to 20 carbon atoms in the alkyl functional groups, in particular dioctyl ethers. Conventional perfume oils which are added in order to scent the laundry are not to be regarded in this case as oil components within the meaning of the invention. In concentrates, oils of this kind can be used in amounts of up to 60 wt. %. In preferred embodiments of the invention, the compositions are free of oils of this kind, however.
optional salts. Inorganic salts are not necessarily required to be able to prepare the microemulsions. However, concentrates, in particular anionic-surfactant-containing concentrates, are preferred which contain one or more inorganic salts. In this case, preferred inorganic salts are alkali metal sulfates and alkali metal halogenides, in particular chlorides, and alkali metal carbonates. Very particularly preferred inorganic salts are sodium sulfate, sodium hydrogen sulfate, sodium carbonate, sodium hydrogen carbonate, sodium chloride, potassium chloride, and mixtures thereof. The content of compositions in concentrate form of one or more inorganic salts is preferably 20 to 70 wt. %. In the microemulsions, the content of one or more inorganic salts is 0 to 20 wt. % and preferably 0.01 to 5 wt. %, concentrations from 0.1 to 1 wt. % having been found to be particularly preferable.
other conventional washing agent ingredients, primarily bleaching agents, builder substances, complexing agents, water-soluble solvents, optical brighteners, fragrances, stabilizers, rheology modifiers, dyes etc.

The liquid surfactant composition according to the invention may contain, as further conventional washing agent ingredients in addition to those mentioned above, at least one, preferably two or more, further constituents selected from the following group: builders, bleaching agents, electrolytes, solvents that are non-aqueous but can be mixed with water, pH adjusters, perfumes, perfume carriers, fluorescing agents, dyes, hydrotropic substances, suds suppressors, silicone oils, anti-redeposition agents, graying inhibitors, anti-shrink agents, anti-crease agents, dye transfer inhibitors, antimicrobial active ingredients, germicides, fungicides, antioxidants, preservatives, corrosion inhibitors, antistatic agents, bittering agents, ironing aids, repellents and impregnating agents, anti-swelling and anti-slip agents, softening components and UV absorbers.

Silicates, aluminum silicates (in particular zeolites), carbonates, salts of organic di- and polycarboxylic acids, and mixtures of these substances are in particular referred to as builders which can be contained in the washing agent composition.

Organic builders which may be present in the washing agent composition are, for example, the polycarboxylic acids that can be used in the form of the sodium salts thereof, polycarboxylic acids being understood to mean those carboxylic acids that carry more than one acid function. These include, for example, citric acid, adipic acid, succinic acid, glutaric acid, malic acid, tartaric acid, maleic acid, fumaric acid, saccharic acids, aminocarboxylic acids, and mixtures thereof. Preferred salts are the salts of polycarboxylic acids such as citric acid, adipic acid, succinic acid, glutaric acid, tartaric acid, saccharic acids, and mixtures thereof. Amino polycarboxylic acids are also suitable, such as glutamine diacetic acid (GLDA) and methylglycinediaecetic acid (MGDA) and the salts thereof.

Polymeric polycarboxylates are also suitable as builders. These are, for example, the alkali metal salts of polyacrylic acid or of polymethacrylic acid, for example those having a relative molecular mass of 600 to 750,000 g/mol. Suitable polymers are in particular polyacrylates which preferably have a molecular mass from 1,000 to 15,000 g/mol. Due to their superior solubility, the short-chain polyacrylates, which have molar masses from 1,000 to 10,000 g/mol, and particularly preferably from 1,000 to 5,000 g/mol, can be preferred from this group.

Copolymeric polycarboxlates, in particular those of acrylic acid with methacrylic acid and acrylic acid or methacrylic acid with maleic acid, are also suitable. The polymers may also contain allyl sulfonic acids, such as allyl oxybenzene sulfonic acid and methallyl sulfonic acid, in the form of monomers, in order to improve the solubility in water.

However, soluble builders, such as citric acid, or acrylic polymers having a molar mass from 1,000 to 5,000 g/mol, are preferably used in the liquid washing agents.

Solvents which are non-aqueous but can be mixed with water can be added to the liquid surfactant composition according to the invention. Suitable non-aqueous solvents include monovalent or polyvalent alcohols, alkanol amines or glycol ethers. For example, the solvents are selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, and mixtures of these solvents.

The liquid surfactant compositions according to the invention can be also formulated, in different embodiments, in the form of single-use portions. This includes in particular containers made of water-soluble materials which are filled with the concentrates according to the invention. Particularly preferred are single-chamber or multi-chamber containers, primarily made of polyvinyl alcohol or polyvinyl alcohol derivatives or copolymers with vinyl alcohol or vinyl alcohol derivatives as a monomer. These single-use portions ensure that the amount of the concentrate according to the invention that is correct for producing the microemulsion system and for the corresponding performance associated therewith is used in the first sub-wash cycle. Optionally, a plurality of single-use portions can also be used depending on the amount of textiles or items of laundry to be washed.

A fourth subject matter of the invention is a method for preparing a liquid surfactant composition, in particular a washing agent, in which

a) substances heated to a temperature T2 are mixed with a microemulsion of the first subject matter of the invention at a temperature T3, and
b) the mixture is subsequently cooled to a temperature T4,
the temperatures T2 and T3 being at least as high as the melting point of at least one above-mentioned non-polymeric, organic thickening agent of the microemulsion and the temperature T4 being below the melting point of said non-polymeric, organic thickening agent.

Using this preparation method, a liquid surfactant composition of the third subject matter of the invention is obtained.

The preferred features of the first subject matter of the invention (e.g. the thickening agent according to the invention, the surfactant system according to the invention and the additional emulsion features (fishtail point, emulsion structure, etc.)) also apply, mutatis mutandis, to the fourth subject matter of the invention.

A preferred method for preparing a liquid surfactant composition is characterized in that at least one above-mentioned non-polymeric, organic thickening agent of the microemulsion has, at 1013 mbar, a melting point of at most 90° C., preferably of at most 85° C., particularly preferably of at most 80° C. It is preferred according to the invention if said thickening agent has a melting point of between 30° C. and 100° C., in particular between 40° C. and 95° C., very particularly preferably from 60° C. to 90° C.

A preferred method for preparing a liquid surfactant composition is characterized in that the substances heated to the temperature T2 contain water, at least one surfactant, or mixtures thereof. In this case, it is in turn preferred if pure water is not mixed with the above-mentioned microemulsion as the first substance. However, if water is to be mixed as the first substance, this is only in a defined amount, such that the microemulsion according to the invention remains temporarily in the mixture. Particularly preferably, first surfactants, and then water, are mixed as the substance with said microemulsion, or a mixture of surfactant and, based on the weight of this mixture, water in an amount of at most 50 wt. %.

The microemulsion used in the method for preparing a liquid surfactant composition was preferably prepared according to a method of the second subject matter of the invention.

Preferably, in a method for preparing a liquid surfactant composition, the microemulsion is prepared using a method of the second subject matter of the invention before step a) and the microemulsion prepared in this way and temperature-controlled to a temperature T1 as before is brought to a temperature T3, with the proviso that
temperature T1≥temperature T3,
T3 is at least as high as the melting point of at least one above-mentioned non-polymeric, organic thickening agent of the microemulsion,
and the obtained microemulsion is introduced at the temperature T3 in step a) of the method.

Within the context of an in-turn preferred embodiment, T3 is at least as high as the highest melting point of the above-mentioned non-polymeric, organic thickening agent of the microemulsion that is used.

The mixture is cooled to temperature T4 preferably gradually. The temperature T4 is preferably at least 10 K below the lowest melting point of the used thickening agent according to the invention. The temperature T4 is preferably at most 40° C., in particular at most 30° C., very particularly preferably room temperature.

The cooling process can preferably be carried out by adding water with a temperature <T4. The water used for cooling may also contain other ingredients of the surfactant compositions according to the invention.

Particulate solids are preferably added thereto and suspended during cooling or after cooling to the temperature T4.

Additives can also be mixed in after cooling to T4.

One embodiment of the invention is described by the following points:

1. A microemulsion, containing, in each case based on the total weight of the emulsion,

a) a liquid phase,

b) a total amount from 2.0 wt. % to 90.0 wt. % of at least one non-polymeric, organic thickening agent having a molecular weight in the range from 100 g/mol to 1500 g/mol as the emulsified phase,

c) a total amount from 2.0 wt. % to 89.0 wt. % of a surfactant system, containing at least one non-ionic surfactant.

2. The microemulsion according to point 1, characterized in that the above-mentioned thickener is in the oil-rich phase of the microemulsion.
3. The microemulsion according to point 1 or 2, characterized in that the liquid phase and the emulsified phase are present as bicontinuous phases or as layers of an L₊-phase, in particular as bicontinuous phases.
4. The microemulsion according to one of the preceding points, characterized in that the surfactant system has a fishtail point in the range from 0.01 wt. % to 80 wt. %, preferably 0.1 wt. % to 70 wt. %, particularly preferably 0.2 wt. % to 60 wt. %.
5. The microemulsion according to one of the preceding points, characterized in that the fishtail point is in the range from 0.01 to 80 wt. % total surfactant and 0.01 to 50 wt. % surfactant C2, preferably 0.1 to 70 wt. % total surfactant and 0.01 to 40 wt. % surfactant C2, most preferably 0.2 to 60 wt. % total surfactant and 0.1 to 35 wt. % surfactant C2.
6. The microemulsion according to one of the preceding points, characterized in that the mean curvature of the amphiphilic film in the single-phase region of the microemulsion is 0 in the temperature range 0 to 100° C., preferably 40 to 98° C., more preferably 60 to 95° C.
7. The microemulsion according to one of the preceding points, characterized in that the total amount of the above-mentioned thickening agent is 5 wt. % to 95 wt. %.
8. The microemulsion according to one of the preceding points, characterized in that the total amount of the above-mentioned thickening agent is at least 5 wt. %, in particular at least 40 wt. %, very particularly preferably at least 50 wt. %.
9. The microemulsion according to one of the preceding points, characterized in that the above-mentioned at least one low-molecular-weight, organic thickening agent is selected from hydrogenated castor oil, 12-hydroxyoctadec-9-anoic acid, 12-hydroxystearic acid, a glyceride having at least two 12-hydroxyoctadec-9-anoic functional groups, triricinolein, a glyceride having at least two 12-hydroxystearic acid functional groups, tris-12-hydroxy stearin, 4,6-O-benzylidene monosaccharide, C₈-C₂₂ alkylamide derivatives of D-glucosamine, urea derivatives, gemini surfactants (in particular N-lauroyl-L-lysine ethyl ester), or mixtures thereof.
10. The microemulsion according to one of the preceding points, characterized in that at least one C₈₋₂₀ alkyl ether, preferably at least one C₈₋₂₀ fatty alcohol alkoxylate having 1 to 10 EO and 0 to 10 PO, is contained as the non-ionic surfactant.
11. The microemulsion according to one of the preceding points, characterized in that the surfactant system additionally contains at least one anionic surfactant.
12. The microemulsion according to point 11, characterized in that the at least one anionic surfactant is selected from C₉-C₁₅ alkylbenzene sulfonate, C₁₀-C₂₀ alkyl ether sulfate having 2 to 10 units of alkylene oxide, dialkylsulfosuccinate of formula (I) or combinations thereof,

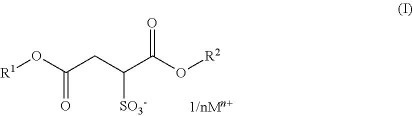

in which the functional groups R¹ and R², independently of one another, are each linear or branched and contain 6 to 22 carbon atoms, preferably 6 to 12 carbon atoms, and are particularly preferably selected from 1-hexyl, 3,5,5-trimethyl-1-hexyl, 2-ethyl-1-hexyl, 6-methyl-1-heptyl, 2-methyl-1-heptyl, 2-propyl-1-pentyl, 2,4,4-trimethyl-1-pentyl, 1-ethyl-2-methyl-1-pentyl, and 1,4-dimethyl-1-hexyl, and 1/n Mnⁿ⁺ is an equivalent of an n-valent cation.

13. The microemulsion according to one of the preceding points, characterized in that the total amount of the above-mentioned surfactant is 1 wt. % to 60 wt. %, in particular 2 wt. % to 50 wt. %.
14. A method for preparing a microemulsion existing at a temperature T1, in which

i) based on the weight of the microemulsion, a total amount from 10 wt. % to 99.0 wt. % of at least one non-polymeric, organic thickening agent having a molecular weight from 100 g/mol to 1500 g/mol as the first liquid phase is mixed with at least one liquid as the second liquid phase, at least one surfactant C1 and at least one surfactant C2, thus producing a cloudy mixture, and

ii) the mixture is brought to a temperature T1 and mixed thoroughly, with the proviso that the temperature T1 is at least as high as the melting point of at least one above-mentioned non-polymeric, organic thickening agent from step i), and a microemulsion is obtained.

15. The method according to point 14, characterized in that the at least one surfactant C2 is mixed in only after step ii).
16. The method according to point 14 or 15, characterized in that the temperature T1 is in a temperature range from 20 to 100° C., preferably 40 to 98° C., more preferably 60 to 95° C.
17. The method according to one of the preceding points, characterized in that a microemulsion according to one of points 1 to 13 is obtained.
18. A liquid surfactant composition, in particular a washing agent, which is obtained by mixing a total amount, based on the total weight of the liquid surfactant composition, from 0.001 wt. % to 5 wt. % of at least one microemulsion according to one of points 1 to 9 with a composition containing water and at least one surfactant, with the provisions that the liquid surfactant composition

contains a total amount from 5 to 80 wt. % of at least one surfactant and

has a yield point, preferably from 0.001 to 6 Pa.

19. The liquid surfactant composition according to point 18, characterized in that it additionally contains suspended solid particles.
20. The liquid composition according to one of points 18 to 19, characterized in that it contains at least one anionic surfactant of formula (A-5),

R³-A-SO₃⁻1/nYⁿ⁺ (A-5)

in which

R³ represents a linear or branched, substituted or unsubstituted alkyl, aryl or alkylaryl functional group,

-A- represents —O— or a chemical bond,

1/n Yⁿ⁺ represents the nth part of an n-valent cation.

21. The liquid surfactant composition according to one of the preceding points, characterized in that it contains, based on the total weight of the composition, anionic surfactant in a total amount from 5.0 to 35.0 wt. %, preferably from 8.0 to 30.0 wt. %, particularly preferably from 10.0 to 25.0 wt. %.
22. The liquid surfactant composition according to one of the preceding points, characterized in that it contains at least one non-ionic surfactant.
23. The liquid surfactant composition according to one of the preceding points, characterized in that at least one non-ionic surfactant of the formula

R²—O—(AO)ₘ—H,

in which

R² represents a linear or branched, substituted or unsubstituted alkyl, aryl or alkylaryl functional group,

AO represents an ethylene oxide (EO) or propylene oxide (PO) group,

m represents an integer from 1 to 50.

24. The liquid surfactant composition according to one of the preceding points, characterized in that, based on the total weight of the surfactant composition, non-ionic surfactant is contained in a total amount from 1.0 to 25 wt. %, preferably 2.5 to 20.0 wt. %, more preferably 5.0 to 18.0 wt. %.
25. The liquid surfactant composition according to one of the preceding points, characterized in that, based on the total weight of the surfactant composition, water is contained in a total amount from 1 to 55 wt. %, in particular from 2 to 50 wt. %, in each case based on the total weight of the composition.
26. The liquid surfactant composition according to one of the preceding points, characterized in that the weight ratio of the surfactant amount of the microemulsion to the total surfactant amount of the liquid surfactant composition is in a range of at most 1 to 2, in particular of at most 1:30, particularly preferably of at most 1 to 100.
27. A method for preparing a liquid surfactant composition, in particular a washing agent, in which

a) substances heated to a temperature T2 are mixed with a microemulsion of points 1 to 13 at a temperature T3, and

b) the mixture is subsequently cooled to a temperature T4, the temperatures T2 and T3 being at least as high as the melting point of at least one above-mentioned non-polymeric, organic thickening agent of the microemulsion and the temperature T4 being below the melting point of said non-polymeric, organic thickening agent.

28. The method for preparing a liquid surfactant composition according to point 27, characterized in that the substances heated to temperature T2 contain water, at least one surfactant, or mixtures thereof.
29. The method for preparing a liquid surfactant composition according to one of points 27 or 28, characterized in that at least one above-mentioned non-polymeric, organic thickening agent of the microemulsion has a melting point of at most 90° C., preferably of at most 85° C., particularly preferably of at most 60° C.
30. The method for preparing a liquid surfactant composition according to one of the preceding points, characterized in that the microemulsion has been prepared in accordance with a method according to points 14 to 17.
31. The method for preparing a liquid surfactant composition according to one of the preceding points, characterized in that before step a), the microemulsion is prepared using a method according to points 14 to 17 and the microemulsion produced in this way and temperature-controlled to temperature T1 as before is brought to a temperature T3, with the proviso that

temperature T1≥temperature T3,

T3 is at least as high as the melting point of at least one above-mentioned non-polymeric, organic thickening agent of the microemulsion,

and the obtained microemulsion is introduced at the temperature T3 in step a) of the method.

32. The method for preparing a liquid surfactant composition according to one of the preceding points, characterized in that a surfactant composition according to one of points 18 to 26 is obtained.

### EXAMPLES

### Preparation of the Microemulsion According to the Invention (Microemulsion Premix 1)

A microemulsion according to the invention was prepared according to the following method:

0.45 g hydrogenated castor oil (HCO) was mixed with 0.134 g dioctyl sulfosuccinate sodium salt (AOT-AS: 97%) and 0.15 g alkyl polyglycol ether (Marlox RT 42-AS: 100%, Sasol) in 0.045 g H2O and melted at 90° C. in order to obtain a first transparent microemulsion.

The uncooled microemulsion obtained in this way is used to prepare the liquid surfactant compositions of examples 1 to 3.

### Example 1

### General Description of the Mixture of Microemulsion Premix With Liquid Washing Agent Premix

A defined amount of the microemulsion premix according to the invention is heated to the desired preparation temperature (see example 3). The amount is selected such that a desired amount of HCO is present in the finished mixture. At the preparation temperature, the components of the liquid washing agent matrix are gradually added to the microemulsion premix. Preferably, the amphiphilic components (surfactants) are initially added and homogenized. In this case, these amphiphilic components are used either as a stock solution with water or in a pure form. The mixture is furthermore homogenized and maintained at the desired temperature. The pH is also adjusted. Subsequently, the mixture is gradually cooled to room temperature and temperature-sensitive components (enzymes, perfume, pigment) are subsequently added. The cooling does not cause the previously set pH to change. The preparation process functions at least just as well, if not better, when the amphiphilic components of the liquid washing agent matrix are brought to the desired preparation temperature and desired amounts of the microemulsion premixes according to the invention are homogeneously mixed therewith. When the amphiphilic components of the liquid washing agent matrix are homogenized with the microemulsion premixes, care should preferably be taken that the desired preparation temperature is kept constant.

TABLE 1
Liquid surfactant composition

| | % active substance |
|---|---|
| Chemical name | in the formula |
| Stabilizer | 1.06 |
| Citric acid | 2.34 |
| Anti-foam additive | 0.04 |
| C12-18 fatty alcohol ether sulfate with 2EO | 7.42 |
| C12-18 fatty alcohol with 7 EO | 5.82 |
| C10-13 alkylbenzene sulfonic acid | 5.82 |
| NaOH | 2.47 |
| Glycerin | 2.66 |
| Complexing agent | 0.53 |
| Preservative | 0.06 |
| Ethanol | 1.32 |
| from microemulsion 1 (premix): | |
| Hydrogenated castor oil (HCO) | 0.90 |
| Dioctyl sodium sulfosuccinate | 0.26 |
| Alkyl polyglycol ether* | 0.30 |
| Temperature-sensitive components: | |
| Enzymes | 0.90 |
| Perfume | 0.78 |
| Pigment | 0.001 |
| Water, up to 100% | |

*Active substance from the raw material Marlox RT 42 ® (Sasol).

This formulation is stable and shows no sign of instability. The resulting yield point of this liquid washing agent matrix mixed with premix microemulsion is 0.3 Pa. Visible beads can be suspended in bulk and evenly distributed. A similar formulation without HCO is unstable (liquid phase separation can be observed) and has no yield point (0.0 Pa). The beads sink and accumulate on the bottom of the flask.

The same formulation mixed with the HCO-containing premixes from EP 1 502 646 B1 and WO 2015/200062 A1 do not produce the above-described results. In this case, the crystallized HCO is in an undissolved state in bulk in the form of one or more white, solid clumps as larger agglomerates on the floor. There is no yield point (0.0 Pa). The visible beads sink to the bottom of the flask and accumulate there.

### Example 2

TABLE 2
Liquid surfactant composition according to the invention

| | % active substance |
|---|---|
| Chemical name | in the formula |
| Stabilizer | 1.12 |
| Citric acid | 3.58 |
| Anti-foam additive | 0.05 |
| C12-18 fatty alcohol ether sulfate with 2EO | 10.07 |
| C12-18 fatty alcohol with 7 EO | 7.84 |
| C10-13 alkylbenzene sulfonic acid | 7.84 |
| NaOH | 3.47 |
| 1,2-propanediol | 6.38 |
| Complexing agent | 0.78 |
| Texcare SRN 170 | 1.46 |
| Ethanol | 2.24 |
| from microemulsion 1 (premix): | |
| Hydrogenated castor oil (HCO) | 0.90 |
| Dioctyl sodium sulfosuccinate | 0.26 |
| Alkyl polyglycol ether | 0.30 |
| Temperature-sensitive components | |
| Optical brighteners | 0.11 |
| Enzymes | 1.86 |
| Perfume | 1.01 |
| Pigment | 0.01 |
| Water, up to 100% | |

* Active substance from the raw material Marlox RT 42 ® (Sasol).

This formulation is stable and shows no sign of instability. The resulting yield point of this liquid washing agent matrix mixed with premix microemulsion is 1.7 Pa. Visible beads can be suspended in bulk and evenly distributed. A similar formulation without HCO is unstable (liquid phase separation can be observed) and has no yield point (0.0 Pa). The beads sink and accumulate on the bottom of the flask.

The same formulation mixed with the HCO-containing premixes from EP 1 502 646 B1 and WO 2015/200062 A1 did not produce any of the above-described results.

The crystallized HCO is in an undissolved state in bulk in the form of one or more white, solid clumps as larger agglomerates on the floor. There is no yield point (0.0 Pa). The visible beads sink to the bottom of the flask and accumulate there.

### Example 3

TABLE 3
Correlation between preparation temperature and resulting
yield point based on results obtained from example 1.

| Preparation temperature | Resulting yield point |
|---|---|
| [° C.] | [Pa] |
| 90 | 0.82 |
| 80 | 0.90 |
| 75 | 1.30 |

The use of premixes according to the invention always leads to the formation of a yield point. These results show a relationship between the preparation temperature during the preparation process of the liquid washing agent formulation and the intensity of the resulting yield point. In this way, the values of the yield points of the liquid washing agent can be set specifically.

What is claimed is:

1. A microemulsion, containing, in each case based on the total weight of the emulsion,
a) a liquid phase,
b) a total amount from 2.0 wt. % to 90.0 wt. % of at least one non-polymeric, organic thickening agent having a molecular weight in the range from 100 g/mol to 1500 g/mol as the emulsified phase,
c) a total amount from 2.0 wt. % to 89.0 wt. % of a surfactant system, containing at least one non-ionic surfactant.

2. The microemulsion according to claim 1, characterized in that the above-mentioned thickener is in the oil-rich phase of the microemulsion.

3. The microemulsion according to claim 1, characterized in that the liquid phase and the emulsified phase are present as bicontinuous phases or as layers of an L_{α}-phase.

4. The microemulsion according to claim 1, characterized in that the surfactant system has a fishtail point in the range from 0.01 wt. % to 80 wt. %.

5. The microemulsion according to claim 1, wherein the surfactant system comprises a plurality of surfactants, comprising at least a first surfactant C1 and a second surfactant C2, wherein the fishtail point is in the range from 0.01 to 80 wt. % total surfactant and 0.01 to 50 wt. % surfactant C2.

6. The microemulsion according to claim 1, characterized in that the mean curvature of the amphiphilic film in the single-phase region of the microemulsion is 0 in the temperature range 0 to 100° C.

7. The microemulsion according to claim 1, characterized in that the total amount of the above-mentioned thickening agent is 5 wt. % to 95 wt. %.

8. The microemulsion according to claim 1, characterized in that the above-mentioned at least one low-molecular-weight, organic thickening agent is selected from hydrogenated castor oil, 12-hydroxyoctadec-9-anoic acid, 12-hydroxystearic acid, a glyceride having at least two 12-hydroxyoctadec-9-anoic functional groups, triricinolein, a glyceride having at least two 12-hydroxystearic acid functional groups, tris-12-hydroxystearin, 4,6-O-benzylidene monosaccharide, C₈-C₂₂ alkylamide derivatives of D-glucosamine, urea derivatives, gemini surfactants, or mixtures thereof.

9. The microemulsion according to claim 1, characterized in that at least one C₈₋₂₀ alkyl ether is contained as the non-ionic surfactant.

10. The microemulsion according to claim 1, characterized in that the surfactant system additionally contains at least one anionic surfactant.

11. The microemulsion according to claim 10, characterized in that the at least one anionic surfactant is selected from C₉-C₁₅ alkylbenzene sulfonate, C₁₀-C₂₀ alkyl ether sulfate having 2 to 10 units of alkylene oxide, dialkylsulfosuccinate of formula (I) or combinations thereof, 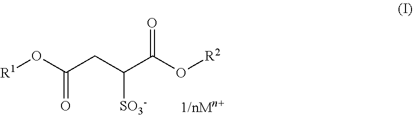
in which the functional groups R¹ and R², independently of one another, are each linear or branched and contain 6 to 22 carbon atoms, and are selected from 1-hexyl, 3,5,5-trimethyl-1-hexyl, 2-ethyl-1-hexyl, 6-methyl-1-heptyl, 2-methyl-1-heptyl, 2-propyl-1-pentyl, 2,4,4-trimethyl-1-pentyl, 1-ethyl-2-methyl-1-pentyl, and 1,4-dimethyl-1-hexyl, and 1/n Mnⁿ⁺ is an equivalent of an n-valent cation.

12. The microemulsion according to claim 1, characterized in that the total amount of the above-mentioned surfactant is 1 wt. % to 60 wt. %.

13. A method for preparing a microemulsion existing at a temperature T1, in which
i) based on the weight of the microemulsion, a total amount from 10 wt. % to 99.0 wt. % of at least one non-polymeric, organic thickening agent having a molecular weight from 100 g/mol to 1500 g/mol as the first liquid phase is mixed with at least one liquid as the second liquid phase, at least one surfactant C1 and at least one surfactant C2, thus producing a cloudy mixture, and
ii) the mixture is brought to a temperature T1 and mixed thoroughly, with the proviso that the temperature T1 is at least as high as the melting point of at least one above-mentioned non-polymeric, organic thickening agent from step i), and a microemulsion is obtained.

14. A liquid surfactant composition which is obtained by mixing a total amount, based on the total weight of the liquid surfactant composition, from 0.001 wt. % to 5 wt. % of at least one microemulsion according to claim 1 with a composition containing water and at least one surfactant, with the provisions that the liquid surfactant composition
contains a total amount from 5 to 80 wt. % of at least one surfactant and
has a yield point.

15. A method for preparing a liquid surfactant composition in which
a) substances heated to a temperature T2 are mixed with a microemulsion of claim 1 at a temperature T3, and
b) the mixture is subsequently cooled to a temperature T4, the temperatures T2 and T3 being at least as high as the melting point of at least one above-mentioned non-polymeric, organic thickening agent of the microemulsion and the temperature T4 being below the melting point of said non-polymeric, organic thickening agent.
